(19) United States
(12) Patent Application Publication
(10) Pub. No.: US 2024/0070626 A1
(43) Pub. Date: Feb. 29, 2024

(54) RESOURCE POOLING AND DISTRIBUTION SYSTEM

(71) Applicant: 7shifts Inc., Saskatoon (CA)

(72) Inventors: Mike Loubardeas, Saskatoon (CA); Henry Collinson, Auckland (NZ); Mazen Beaini, Mississauga (CA); Melissa Venditti, Calgary (CA); Ingrid Coutinho Precht Goerl, Saskatoon (CA); Dakarai Omari Turner, Toronto (CA); Autumn Rayne Dawe-Baillie, Saskatoon (CA); Dustin Weeres, Saskatoon (CA); Jasmine Acebes, Mississauga (CA); Shelby Thomson, Saskatoon (CA); Ryan Michael-Maxwell Hoppe, Saskatoon (CA); Scott Da Costa Moniz, Toronto (CA); Tyson Lemire, Saskatoon (CA); Corey Ray Janzen, Hague (CA)

(21) Appl. No.: 18/238,358

(22) Filed: Aug. 25, 2023

Related U.S. Application Data
(60) Provisional application No. 63/401,383, filed on Aug. 26, 2022.

(51) Int. Cl. G06Q 20/06; G06Q 20/38; G06Q 20/40

(52) U.S. Cl. CPC G06Q 20/06; G06Q 20/389; G06Q 20/4014

(57) ABSTRACT

Methods, systems, and apparatus, including computer programs encoded on computer storage media, for performing tip-pooling aggregation and distribution. In some implementations, data is extracted from a plurality of different data sources. The data is normalized to a same format. The normalized data, which is attributed to a remote identifier, is indexed to an identifier representing a same source as the remote identifier. Portions of the normalized data indexed to the same contribution source are allocated to buckets based on a contribution period and a role for the same contribution source and a rule applicable to the contribution period. Portions of the normalized data indexed to different contribution sources are aggregated in the buckets to different contribution sources according to the allocation rule. The aggregated portions of the normalized data are assigned to targets based on assignment rules applicable to the buckets and distribution targets active during the contribution period.

### CROSS-REFERENCE TO RELATED APPLICATION

This application claims the benefit of U.S. Provisional Application No. 63/401,383 filed on Aug. 26, 2022, and titled “Resource Pooling and Distribution System,” which is incorporated herein by reference.

### TECHNICAL FIELD

This specification generally relates to computer systems, and one particular implementation relates to allocation and distribution of resource data from various computer systems.

### BACKGROUND

Resource allocation can be performed in a number of contexts, such as cloud computing contexts, memory device management, network communications, and other applications. Solutions for performing resource allocation generally identify a set of limited resources, and allocate those limited resources in a way that is consistent with resource allocation rules, and achieves a specified goal.

### SUMMARY

In one general aspect, a method can include the operations of extracting, by one or more processors and from a plurality of different data sources, available resource data in a plurality of formats; normalizing, by the one or more processors, the available resource data to a same format that is recognized by the one or more processors to create normalized resource data; indexing, (i) by the one or more processors and (ii) for each given remote user identifier among a set of remote user identifiers included in the available resource data by the plurality of different data sources, the normalized resource data that is attributed to the given remote user identifier to a corresponding identifier representing a same resource contribution source as the given remote identifier; allocating, by the one or more processors, portions of the normalized resource data indexed to the same resource contribution source to a plurality of resource allocation buckets based on a resource contribution period for the same resource contribution source and an allocation rule applicable to the resource contribution period and a role of the same resource contribution source; aggregating, by the one or more processors and in the resource allocation buckets, portions of the normalized resource data indexed to different resource contribution sources to which the allocation rule is applicable; and assigning, by the one or more processors, the aggregated portions of the normalized resource data to a plurality of resource targets based on one or more resource assignment rules applicable to the resource allocation buckets and resource distribution targets that were active during the resource contribution period.

Other embodiments of this and other aspects of the disclosure include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The foregoing and other embodiments can each optionally include one or more of the following features, alone or in combination. For example, one embodiment includes all the following features in combination.

In some implementations, the available resource data in the plurality of formats includes a sales receipt, a time stamp of a transaction, a remote user identifier corresponding to a user that submitted the available resource data, and a device ID corresponding to a data source that transmitted the available resource data.

In some implementations, the method includes fetching, by the one or more processors, the available resource data from a subset of the plurality of different data sources on a periodic basis based on a type of the data sources; or receiving, by the one or more processors and from the plurality of different data sources, the available resource data in the plurality of formats.

In some implementations, normalizing the available resource data to the same format that is recognized by the one or more processors to create normalized resource data further includes: identifying, by the one or more processors, a type of a data source that transmitted the available resource data; identifying, by the one or more processors, an application programmable interface associated with the type of the data source that transmitted the available resource data; and generating, by the one or more processors, the normalized resource data by applying one or more functions of the application programmable interface to the available resource data associated with the type of the data source.

In some implementations, indexing, (i) by the one or more or processors and (ii) for each of the given remote user identifier among the set of remote user identifiers included in the available resource data by the plurality of different data sources, the normalized resource data that is attributed to the given remote user identifier to the corresponding identifier representing the same resource contribution source as the given remote identifier further includes: for each available resource data from each of the plurality of different data sources: identifying, by the one or more processors, the set of remote user identifiers; extracting, by the one or more processors, a remote user identifier from the normalized resource data; mapping, by the one or more processors, the extracted remote user identifier to the corresponding identifier from the set of remote user identifiers that represents the same resource contribution source as the given remote identifier; and storing, by the one or more processors, the normalized resource data in an indexed fashion using the corresponding identifier in memory.

In some implementations, allocating portions of the normalized resource data indexed to the same resource contribution source to the plurality of resource allocation buckets based on the resource contribution period for the same resource contribution source and an allocation rule applicable to the resource contribution period and the role of the same resource contribution source further includes: identifying, by the one or more processors, a user who contributed the resource data based on the remote user identifier; identifying, by the one or more processors, a format indicative of how the resource data was received by a corresponding data source, wherein the format indicative of how the resource data was received comprises (i) resource data from time entries and (ii) resource data from receipt produced by the corresponding data source; and identifying, by the one or more processors, a resource allocation bucket from the plurality of resource allocation buckets to allocate portions of the normalized resource data based on (i) the identifier user who contributed the resource data, (ii) the format indicative of how the resource data was received by the corresponding data source, (iii) the resource contribution period, (iv) the allocation rule applicable to the resource contribution period, and (v) the role of the same resource contribution source.

In some implementations, the plurality of resource allocation buckets include (i) one or more buckets associated with the corresponding identifier representing the same resource contribution source for the normalized resource data associated with the remote user identifier, (ii) one or more buckets for the normalized resource data that is associated with a time punch entry system, and (iii) one or more buckets for the normalized resource data that is unassigned to the remote user identifier.

In some implementations, aggregating the portions of the normalized resource data indexed to the different resource contribution sources to which the allocation rule is applicable further includes: aggregating, by the one or more processors, the portions of the normalized resource data from the plurality of resource allocation buckets across different servers, wherein a subset of the servers store the available resource data that are provided by the resource distribution targets separate from the plurality of different data sources.

In some implementations, the subset of the servers that store the available resource data that are provided by the resource distribution targets separate from the plurality of different data sources include storing declared tips from the resource distribution targets that were active during the resource contribution period.

In some implementations, the resource distribution targets comprise one or more employees in a service industry.

In some implementations, the resource contribution period corresponds to a time period during which the resource distribution targets were active, and the resource contribution period includes at least one of (i) a morning period, (ii) an afternoon period, (iii) a night time period, (iv) hours worked, and (v) a shift period of work.

In some implementations, assigning the aggregated portions of the normalized resource data to the plurality of resource targets based on the one or more resource assignment rules applicable to the resource allocation buckets and the resource distribution targets that were active during the resource contribution period further includes: determining a distribution type associated with the plurality of resource allocation buckets, wherein the distribution type comprises (i) an equal distribution configured to distribute an equal portion of the normalized resource data from each resource allocation bucket of the plurality of resource allocation buckets, (ii) a percentage distribution configured to distribute a percentage of the normalized resource data from each resource allocation bucket of the plurality of resource allocation buckets based on a designated distribution, and (iii) a points distribution configured to distribute a ratio of the normalized resource data from each resource allocation bucket of the plurality of resource allocation buckets based on the designated distribution.

In some implementations, assigning the aggregated portions of the normalized resource data to the plurality of resource targets based on the one or more resource assignment rules applicable to the resource allocation buckets and the resource distribution targets that were active during the resource contribution period further includes: transmitting, by the one or more processors, the assigned aggregated portions of the normalized resource data to the plurality of resource targets specified by the different resource contribution sources; and wherein the resource distribution targets that were active during the resource contribution period comprises the resource distribution targets that were working during the resource contribution period.

In some implementations, the method includes: identifying, by the one or more processors, a resource distribution target is associated with two or more resource allocation buckets, wherein the identifying comprises: determining, by the one or more processors, the resource distribution target is associated with the two or more resource allocation buckets; determining, by the one or more processors, whether the resource distribution target has contributed an amount of resource data that satisfies a threshold tip amount across the two or more resource allocation buckets; in response to determining that the amount satisfies the threshold tip amount across the two or more resource allocation buckets, traversing, by the one or more processors, each resource allocation bucket of the two or more resource allocation buckets to identify the normalized resource data that are similar based on (i) a timestamp and (ii) a remote user identifier; and in response to determining one or more normalized resource data across the two or more resource allocation buckets that include (i) similar amounts, (ii) similar remote user identifiers, and (iii) similar timestamps, removing, by the one or more processors, at least one of the normalized resource data from at least one of the resource allocation buckets to avoid double counting the normalized resource data.

These and other embodiments of the subject matter disclosed herein can provide one or more advantages/improvements over conventional systems. For example, the subject matter described herein can result in a more efficient resource allocation system in which resources are allocated to recipients more quickly than conventional techniques for allocating resources to recipients. More specifically, rather than taking hours, days, or weeks to allocate resources to a set of recipients, the techniques discussed herein can perform the resource allocation in essentially real-time (e.g., within seconds or minutes of a trigger event that results in resources being allocated to recipients). Furthermore, the subject matter described herein enables accurate real-time tracking of resources that have already been allocated to recipients relative to resources that are committed for allocation to the recipients, thereby providing a higher level of transparency regarding the allocation of a limited set of resources among recipients.

The subject matter described herein is also configured to function with different datasets having different formats, thereby providing a system agnostic solution that is capable of identifying a structure of received data and converting that data for use in the system. This reduces the amount of setup and time required to modify systems to provide interoperability, which results in a more flexible system that can be brought online more quickly than conventional systems that require data received to have a pre-specified structure for processing. For example, when the system receives data for processing, the system can identify the relevant aspects of the data and extract the relevant data for use by the system.

The subject matter described herein also provides the ability to seamlessly pool resources from multiple different sources, aggregate the total amount of resources, and distribute the aggregated resources among multiple different recipients using a user-specified (e.g., administrator specified) allocation plan. For example, a user of the system can specify a set of rules defining an allocation plan that specifies rules as to how the resources will be allocated to a set of recipients based on various characteristics of the recipients. This enables the system to effectively implement/automate a more complex resource distribution plan with fewer errors than may be experienced using traditional resource allocation systems. The automation of the complex resource distribution plan also enables the allocation to occur more quickly than when using conventional systems/techniques because the data used for the resource allocation can be acquired in real time when the trigger events occur, and proceed to apply the rules of the allocation plan without the added latency of making determinations as to the allocation of resources to recipients at the end of longer time periods.

The subject matter described herein also provides an improvement over prior systems by distributing the aggregated resources in real time or substantial real time in a standardized format regardless of the format the pooled resources were provided by the multiple different sources. For example, each source of the multiple different sources can provide their respective resource data to the system in a non-standardized manner in real time. The system can receive resource data from each source of the multiple different sources and convert or normalize the received resource data into a standardized format such that the system can apply similar functions to the resource data. By converting the received resource data into the standardized format, the system can apply a set of functions that work across all standardized data and not require the system to use individual functions that pertain to each type of non-standardized data. An overall memory footprint is reduced in the system as a smaller set of functions can be used on the standardized data rather than having to store a larger set of individualized functions for the non-standardized data, ultimately improving memory utilization. In response, the system can aggregate each of the standardized resources into buckets according to a user-specified allocation plan. A message can be automatically generated and transmitted to a client device of a user, e.g., a manager or system administrator, or displayed on a graphical user interface each time the resource data is stored in buckets. In this manner, the user can be notified in real time of the aggregated resources stored in the buckets and the aggregated resources can be subsequently distributed to the users either through instant deposit, through payroll, or through another path.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram that illustrates an example of a system for resource pooling aggregation and distribution.

FIG. 1B is a flow diagram that illustrates an example of resource pooling aggregation and distribution.

FIGS. 2A-2G are examples of user interfaces that illustrate the creation of a resource pool for aggregation and distribution.

FIG. 3A illustrates examples of flow diagrams for creating instant distribution from a created resource pool.

FIG. 3B illustrates examples of flow diagrams for resource pooling workflow and resource payment workflow for a created resource pool.

FIG. 4 illustrates an example of a flow diagram for resource pooling aggregation and distribution using platformization.

FIG. 5 is an example of a user interface that illustrates the creation of a customizable distribution from a created resource pool.

FIGS. 6A-6B are examples of a user interface for worked hours and wages report.

FIG. 7 is an example of a user interface illustrating distribution payouts across a set time period for a created resource pool.

FIG. 8 is a flow diagram that illustrates an example of a process for aggregating resource data and distributing the aggregated resource data according to criteria.

Like reference numbers and designations in the various drawings indicate like elements. The components shown here, their connections and relationships, and their functions, are meant to be examples only, and are not meant to limit the implementations described and/or claimed in this document.

### DETAILED DESCRIPTION

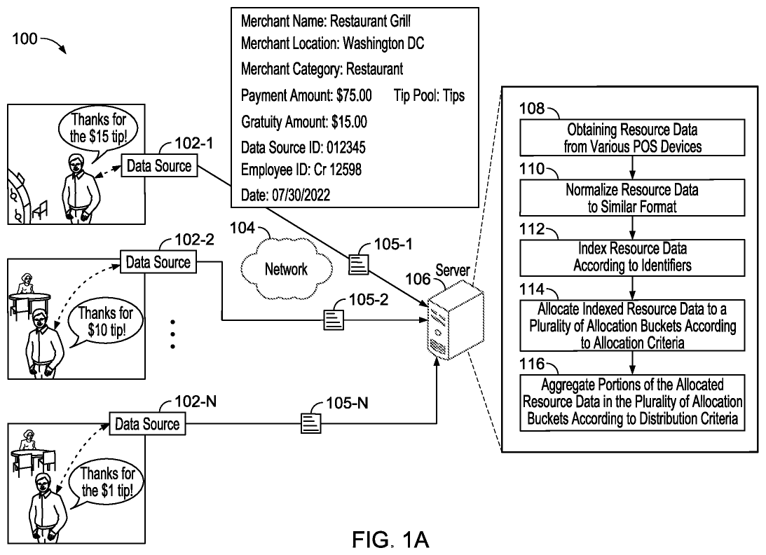

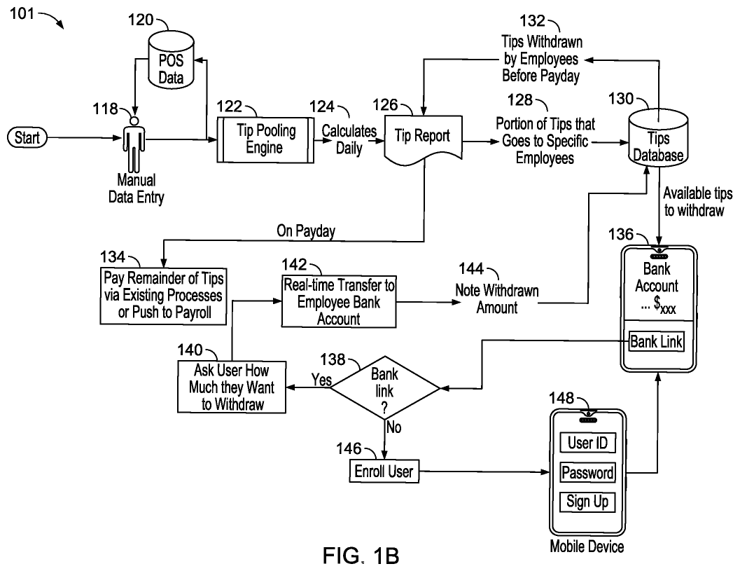

FIG. 1A is a block diagram that illustrates an example of a system 100 for resource pooling aggregation and distribution. Specifically, the system 100 can be an environment in which various disparate data sources provide tip or sales data (hereinafter “resource data”) to a server 106 and the server 106 determines how to distribute the resource data, accordingly. The server 106 can acquire the resource data from disparate data sources across different geographic regions from different service providers, e.g., merchants, services, and vendors, and receive each resource data in a format respective to the provided data source. The server 106 can normalize the resource data to a format understood by the server 106 for processing and allocate the acquired resource data into multiple buckets based on a predetermined set of rules. In response, the server 106 can determine a distribution method for distributing the allocated resource data from each of the buckets to various entities or departments based on the amounts contained in each of the buckets and the rules associated with each of the buckets.

The system 100 and techniques discussed herein can be used across multiple different resource allocation contexts. For example, the techniques discussed herein can be used to identify a set of limited resources (e.g., computing resources, natural resources, or financial resources) that are made available by different sources, and distribute those resources among a set of entities to satisfy a set of allocation rules.

In some implementations, the system 100 can be performed in a hospitality environment. In some examples, the system 100 can be performed in a restaurant, a cafe or coffee shop, a sports game, a bar, or any other type of hospitality environment. In some examples, the system 100 can be performed in environments in addition to the hospitality environment. These environments can include, for example, casinos, golf courses, ski resorts, public transportation, and hotels, to name a few examples. Of course, similar techniques can be used to allocate any limited resource, including, for example, cloud computing resources, and the technical aspects of the solutions described herein are not limited to use in the context of the hospitality environment.

In some implementations, the system 100 can be performed in a server farm environment. In a server farm environment, a group, cluster, or collection of computer servers can supply server functionality that extends beyond the capability of a single machine. For example, in the server farm environment, each server can perform a specific function and provide results of that function, e.g., “data resource,” to a central server, e.g., server 106, for determining distribution of the data resources according to set criteria.

In the hospitality example, the server 106 can aggregate pooling resources and distribute the pooled resources according to a set of rules. For example, a customer may desire to add a tip (also referred to as a gratuity) when paying for a good or service, such as paying for a meal at a restaurant or paying for the service performed by one of the employees at a restaurant. To do so, the customer can complete a payment transaction for the meal at the restaurant. Typically, the customer can use a portable consumer device, e.g., such as a credit card, a debit card, a smart card, a mobile phone, or other device, to pay for the meal or other goods and services from the merchant. The customer can enter tips by way of electronic payments, which can be recorded by the various devices, such as point of sale (POS) systems, mobile devices and their applications, client device, or other devices. Similarly, the customer can provide cash tips and the employee that collected the cash tip can declare the cash tip (hereinafter “declared tips”) through an application on their client device, for example, that enables them to input the amount of declared tips collected during their shift.

Companies can also collect resource data that is input at the physical location of the company. For example, in a restaurant industry, waiters or bartenders can serve food or drink to customers. Customers can pay the waiters or bartenders for their services in cash, credit cards, mobile transactions, and other forms of payment. While POS devices, mobile applications, client devices, or other devices can record tips that are included in electronic payments, the employee who collected the cash tips can declare the cash tips. In this situation, the employee can access an application that enables them to directly input the amount of cash tips they collected during their shift. This cash tip information can be transmitted to the system, which can combine this cash tip information with the resource data obtained from the various POS systems, so that the total tip information from the different tip sources is available to the system, which is referred to as “available resources”. In some situations, the available resources can be delineated on a day part basis, shift basis, method of tip payment, an area of dining, a dining option, or another appropriate criterion, so that the available resources collected correspond to the staff that was responsible for generating the available resources.

The server 106 can obtain worked hours or time punches (referred to as “labor data”) for the employees. The various devices can provide the labor data and the resource data to the server 106. For example, the labor data can indicate that employee 1, who is a waiter, worked the morning shift from 9:00 AM to 12:00 PM. The various devices can also insert a user identifier, e.g., “USERID1111” for user 1 that entered or collected the tips from this bill. The resource data can indicate that employee 1 obtained a $25 tip from a first bill, a $20 tip from a second bill, a $5 tip from third bill, and a $6 tip from a fourth bill, to name a few examples. Similarly, the resource data can include a cash tip received by user 1.

The system 100 can process the acquired resource data from each of the devices and determine how to distribute the resource data according to a set of criteria. Specifically, the server 106 can orchestrate the creation of a tipping pool (hereinafter “resource pool”) that stores the acquired resource data into multiple tipping buckets. The resource pool can be a system configured to obtain and aggregate resource data, allocate the aggregated resource data to one or more buckets of the multiple tipping buckets within the resource pool, and distribute the allocated resource data from one or more tipping buckets of the multiple tipping buckets to one or more defined users. For example, a restaurant manager may desire to manage the tipping contribution and distribution for their employees by utilizing a resource pool created by system 100. The restaurant manager can set up the resource pool to be used by each of his employees, e.g., chefs, sous chefs, bartenders, waiters, waitresses, janitorial staff, bus boys, hosts, and hostesses, to name a few examples. The restaurant manager can instantiate the resource pool and give his employees access to manage the resource pool for managing their tipping contributions and distributions. For example, the creating and editing of tip pools is a manager-configurable permission which can be accessed by the employees through their respective client devices. Moreover, these employees can monitor and edit their contributions and distributions criteria for their tip pools using their respective client devices.

In some implementations, the restaurant manager can configure the resource pool with varying levels of granularity for specifics by interacting with an interface coupled to the server 106. The restaurant manager can set, for example, user identifiers associated with the employees, a number of specific resource pools within a single resource pool, a number of buckets within each resource pool, characteristics for using each of the resource pools, and characteristics for each of those buckets within each resource pool.

Additionally, the restaurant manager can set characteristics associated with the contributions to each resource pool. The characteristics associated with the contributions to each resource pool can include, for example, characteristics associated with the users who can contribute to each of the specific resource pools and characteristics associated with types of contributions to each of the specific resource pools. The restaurant manager can also configure the roles of each user or employee that is to be associated with each specific resource pool. For example, the restaurant manager can define that the user “Craig” has a role of “Bartender” and the user “John” has a role of “Chef” The server 106 can utilize the role identifications later for inferring roles from sales receipt information from labor data information acquired during implementation, which will be further described below.

For example, the set of contribution rules can specify that resources from a first entity category or role will contribute X₁% of their resources to bucket A and will contribute X₂% of their resources to bucket B. The set of contribution rules can also specify that tips generated by an entity having a second role will contribute X₃% of their generated tips to bucket A and X₄% of their generated tips to bucket B. In this example, bucket A will contain a sum of X₁% of the tips generated by employees in the first role and X₃% of the tips generated by employees in the second role. Meanwhile, bucket B will contain a sum of X₂% of the tips generated by employees in the first role and X₄% of the tips generated by employees in the second role.

The restaurant manager can also set characteristics associated with the distributions from each resource pool. Specifically, the characteristics associated with the distributions can dictate how the server 106 distributes or pays out the allocated resources from the multiple buckets associated with each resource pool. The characteristics associated with the distributions can include, for example, characteristics associated with the users or employees who receive allocated resource distributions based on their configured role and types of resource distributions from each resource pool. In some implementations, each resource pool can be configured with a specific resource distribution type. In some implementations, a resource pool can be cascaded into a separate resource pool. As will be further described below, a cascaded resource pool includes resource distributions that are input to a first resource pool, distributions of the first resource pool are then input into a second different resource pool, and distributions of the second resource pool are then output to users or employees based on their configured role.

Continuing with the example above, the resource assignment rules for bucket A can specify that 50% of the available resources in bucket A are to be distributed to host staff, and that the other 50% of the available resources in bucket A are to be distributed to waiters. Meanwhile, the resource assignment rules for bucket B can specify that 60% of the available resources in bucket B are to be distributed to bartenders, while 40% of the available resources in bucket B are to be distributed to managers. Other examples are also possible. Using these rules, the system can assign the resources to the employees based on their roles and in the specified proportions.

In some situations, the rules can be more complex and take into account other various characteristics. Specifically, one or more algorithmic processes can analyze the various characteristics to determine how to distribute the available resources using information beyond the workers' employment roles. For example, in the context of a restaurant, the one or more algorithmic processes can analyze, for each waiter or waitress that contributed the resource data, an hourly amount of shift work for the waiter, an hourly amount of shift work for the waiter per day part, a waiter's schedule for working at the restaurant, a seniority of the waiter, a location worked at the restaurant, e.g., indoors or outdoors, and other factors. Based on the analysis, the system can determine an amount of the available resources that is to be distributed to each employee. For example, the output of the analysis can be a weighting factor (or another adjustment factor) that can be used to scale the distribution of available resources among employees in a same role. Other exemplary situations are also possible.

In some implementations, the server 106 can set up a resource pool based on a user's request. Continuing with the restaurant manager example, the restaurant manager can transmit a request to server 106 to set up or create a resource pool for his restaurant and the employees. Specifically, the restaurant manager can provide user identifiers associated with the employees for the newly created resource pool in response to providing the request to the server 106. The user identifiers can include, for example, a hash value, a key value, a number, a short word, or another value that identifies the employees. As such, each employee can be associated with a specific user identifier.

In response to providing a user identifier for each employee to utilize the resource pool, the server 106 can create an internal identifier for the employee. In some implementations, the internal identifier can be different from the user identifier supplied by the restaurant manager. In some implementations, the internal identifier can be the user identifier supplied by the restaurant manager. The internal identifier can be stored in one or more databases connected with or associated with the server 106. The server 106 can use the internal identifier as an index to store resource data and corresponding labor data associated with each employee that utilizes the resource pool. In some implementations, the server 106 can store a mapping for the identifiers. In the implementation where the user identifier is different from the internal identifier, the server 106 can store the mapping of the user identifier to the internal identifier. In this case, when the server 106 receives resource data and corresponding labor data from devices, the server 106 can map the user identifier from resource data to the internal identifier. As a result, the server 106 can store the resource data and the corresponding labor data in the database according to the internal identifier. At a later point in time, the server 106 can access the resource data and the corresponding labor data using the internal identifier as an index.

The restaurant manager can also define a number of specific resource sub-pools within a single resource pool using the server 106. For example, the restaurant manager can define a single resource pool to have three resource sub-pools. Each of the three resource sub-pools can include multiple buckets. The restaurant manager can identify each of the three resource sub-pools to be selected and used according to various criteria. For example, the various criteria can include a day part basis, a shift basis, a method of tip payment, an area of dining, a dining option, or another appropriate criterion so that the resource data is properly allocated to the correct resource pool.

In some examples, the day part basis can include different tip pools for employees in different times of day. For example, the restaurant manager can configure three-day part basis—a morning shift from restaurant opening to 11:00 AM, an afternoon shift from 11:00 AM to 3:00 PM, and a dinner shift from 3:00 PM to closing time. Each shift can correspond to one of the three resource pools. If the server 106 determines from the resource data that an employee who is associated with the resource pool worked from 8:00 AM to 11:00 AM, then any tips accrued by this employee can be allocated to the first resource pool associated with the morning shift. Similarly, if the server 106 determines from the resource data that an employee who is associated with (e.g., a member of) the resource pool worked from 2:00 PM to 6:00 PM, then the server 106 can determine that any tips accrued by this employee from 2:00 PM to 3:00 PM can be allocated to the second resource pool and any tips accrued by this employee from 3:00 PM to closing time can be allocated to the third resource pool. Other example configurations are also possible, such as more than three-day configurations for the day part basis or less than three-day configurations.

In some implementations, the shift basis can include different tip pools for employees depending on a shift worked. The shift basis can include periods of work separate from the day part basis. For example, the server 106 can associate a resource pool with a morning shift, e.g., a shift that lasts from opening to 12:00 PM, and another resource pool with an afternoon shift, e.g., a shift that lasts from 12:00 PM to closing time. For example, the server 106 can associate a resource pool with a night shift, e.g., a shift that lasts from 7:00 PM to 12:00 AM.

In some implementations, the method of tip payment can include different tip pools that correspond to a method of how tips are paid by customers. Specifically, the method of tip payment can vary by, for example, cash payment, credit card payment, debit card payment, and touchless transactions by mobile device, to name a few examples. The server 106 can configure a specific tip-pool for each type of tip payment. Upon receiving a tip payment, the server 106 can assign the tip payment to a specific tip-pool depending on the type of tip payment.

In some implementations, the area of dining can include different tip pools that correspond to different dining areas. For example, the server 106 can define a tipping pool for an outside area of dining and another tipping pool for an inside area of dining. In some examples, the server 106 can also define a tipping pool for an upstairs area of dining and another tipping pool for a downstairs area of dining. The server 106 can also define more granular dining areas and associate these with tipping pools, such as upstairs during the night shift is associated with a first tipping pool, upstairs during the morning shift is associated with a second tipping pool, downstairs area during the morning shift is associated with a third tipping pool, and downstairs area during the night shift is associated with a fourth tipping pool. Other combinations and examples are also possible.

Similarly, the server 106 can receive criteria that associates a sales category associated with a tipping pool. For example, the server 106 can receive a criterion that associates a choice of appetizer with a specific tipping pool, a choice of entree with a specific tipping pool, and a choice of dessert with a specific tipping pool, to name some examples of sales categories. In this manner, the server 106 can track tips received when a customer orders a specific sales category. In some examples, the server 106 can receive a criterion that associates a dining option with a particular tipping pool. The dining option may include, for example, a breakfast meal, a lunch meal, a dinner meal, or any other meals.

In some implementations, if the server 106 determines that the same customer ordered an appetizer, an entree, and a dessert that each have a separate tipping pool, then the server can divide the tip received from the customer paying the bill across the separate tipping pools. For example, if the server 106 determines that the customer purchased an appetizer that has a tipping pool, an entree that has a separate tipping pool, and a dessert that does not have a tipping pool, then when the server 106 receives a tip from the bill, the server 106 can evenly split the tip across the entree tipping pool and the appetizer tipping pool. In some examples, the server 106 can split the tip proportionately according to the cost of the corresponding meal. Continuing with the example above in which the dessert does not have a tipping pool, if the entree costs $30 and the appetizer costs $5, then the server 106 can provide 5/35 of the tip into the appetizer tipping pool and 30/35 of the tip into the entree tipping pool. Other examples are also possible.

In some implementations, the server 106 can receive a criterion that defines a number of buckets within each resource pool and when to use the specific buckets within each resource pool. For example, the criteria can indicate that a resource pool can include three buckets. In some examples, the criteria can indicate that a resource pool can include five buckets. Other examples are also possible. For the resource pool with three buckets, a bucket can correspond to a software storage container. The software storage container can include, for example, a struct, a library, a class, an array, or an object, to name a few examples.

The server 106 can receive criteria that designates a corresponding function for each bucket. For example, in the resource pool with three buckets, the first bucket can represent a bucket that stores resource data from sales receipt. The second bucket can represent a bucket that stores resource data that does not belong to any contribution roles in the corresponding resource pool. The third bucket can represent a bucket that stores resource data that is unassigned to a contribution role. Moreover, in the third bucket, the server 106 was not able to associate any of the roles to the labor data or the server 106 was not able to identify a corresponding role for the received labor data. The server 106 may define custom rules for distributing the allocated resource data from the third bucket since this allocated resource data is not associated with a particular role or not associated with the labor data. Other examples are also possible.

In some implementations, each of the buckets can be configured for a particular function. A bucket's function is flexible, in that a user can configure the function of a bucket for a desired purpose. In some examples, a bucket can be configured for a tip contribution with one or more filters. The filters can include, for example, dining options (DOs), rev centers (RCs), sale categories, and other filter options. In some examples, a bucket can be configured for a sales contribution with one or more filters. These filters can include, for example, DOs, RCs, sales categories, and other filter options. Moreover, a bucket can also be assigned an unassigned filter configuration. In the unassigned filter configuration, a bucket can receive contributions which have been unassigned by the server 106.

In some implementations, the server 106 can define a same role multiple times for various contribution buckets with different percentages and filters. For example, for one bucket, a waiter can be configured to contribute 5% of tips for alcohol sales and 2.5% of tips for food sales. This example can also be configured across multiple buckets, where a waiter can contribute to multiple buckets, and each waiter can have multiple roles for each bucket of the multiple buckets. In some examples, the server 106 can contribute a flat 1% of all net sales from the POS devices to one or more of the buckets. Other examples are also possible. A manager or other administrator can define the configurable rules for the buckets and for the employees that contribute and receive contributions from the buckets.

In some implementations, the server 106 can identify characteristics for using each of the resource pools. When an individual creates a specific tipping pool, or multiple tipping pools within a single resource pool, the server 106 can receive data that identifies which users can deliver tips to the specific tipping pool. For example, the restaurant manager can define various user identifiers that describe which users can contribute to the specific tipping pool. The restaurant manager can indicate to the server 106 that user 1 with user identifier “USERID1111,” user 2 with user identifier “USERID1112,” and user 3 with user identifier “USERID1113” can each access a specific tipping pool. The server 106 can receive the user identifiers and create internal identifiers. As mentioned, the server 106 can store (i) the internal identifiers and (ii) a mapping between the user identifiers and the internal identifiers in a database for later retrieval. In some implementations, the restaurant manager can indicate to the server 106 which roles can contribute and/or distribute to the specific tipping pool. The roles can include, for example, the roles of the employees at the restaurant. The server 106 can receive role identifiers for each of the employees and can associate each role identifiers with one or more specific tipping pools.

The server 106 can also store data that identifies which corresponding internal identifiers correspond to which specific resource pool. For example, the server 106 can determine that user 2's user identifier “USERID1112”, which maps to internal identifier of “X(#*@!$ #”, can use (i) a tipping pool for a morning shift day part and (ii) a separate tipping pool for a night shift day part. Thus, when the server 106 receives resource and labor data from for the user 2, the server 106 can determine which of the two tipping pools (i) or (ii) the resource data should be stored based on the time of day the resource data was acquired. Moreover, by mapping internal identifiers to specific tipping pools, the server 106 can enforce that the user does not contribute to any other tipping pools than those specified by the restaurant manager. This ensures double counting of tips is avoided and no errors exist during the accumulation of tip distribution.

In some implementations, the server 106 can receive a criterion that defines employee contributions and characteristics of the contributions to a resource pool. In some examples, the employee contributions can be defined on a per role basis. In some examples, the employee contributions can be defined on a user basis. Continuing with the example from above, the restaurant manager can provide data to the server 106 that indicates departments, e.g., hospitality and cooking department, that can contribute to a resource pool, individuals that can contribute to a resource pool, and roles that can contribute to a specific resource pool. In some implementations, the server 106 can determine which specific users under roles are not configured for one or more tip pools. These users may be excluded from contributing and receiving distributions from these tip pools until designated to do so by a manager or administrator at a later point in time. As such, the restaurant manager can define identifiers for the server 106 for each of the departments that can contribute to the specific pool and the server 106 can associate the identifiers with internal identifiers for storing resource data and corresponding labor data, and ultimately, enabling the resource data to be stored in the specific pool.

In some implementations, the server 106 can define multiple mechanisms for a user's contribution of tips to a specific resource pool. Specifically, the server 106 can define one mechanism as (i) a percentage of tips contribution and (ii) a percentage of sales contribution. In the (i) percentage of tips contribution, the server 106 can aggregate a percentage of the resource data for a specific role or user for a time period and adjust the aggregated resource data according to a stakeholder stake factor. The stakeholder stake factor can be, for example, a weighted value, a percentage, a decimal, a scale, or another factor that adjusts the aggregated resource data to create a scaled resource data amount for the tip pool.

For example, in the percentage of tips contribution, the server 106 can determine that the aggregated resource data for user 1 for a particular day is $25 for tip 1, $26 for tip 2, $20 for tip 3, $19 for tip 4, and $10 for tip 5. The server 106 can identify a percentage factor to multiply each of the tip amounts for user 1. The percentage factor can be a percentage factor assigned by the restaurant manager for a given role, e.g., 30%. Then, the server 106 can multiply each tip amount by the percentage factor. Thus, the server 106 can multiply 30%*(25+26+20+19+10) to determine a value of $30.

In response, the server 106 can identify and retrieve the corresponding stakeholder factor for user 1 according to their internal identifier and multiply the aggregated tip data by the retrieved stakeholder factor. The stakeholder factor for user 1 may be 50%. The stakeholder stake factor can include a factor that is different from the percentage factor previously identified. The server 106 can then multiply the summed tip amount of $30 by the stakeholder stake factor to determine the scaled resource data amount. As such, the server 106 can determine the scaled resource data amount for the tip-pool is $30*50%, which is $15. The server 106 can then store the scaled resource data amount of $15 in the first bucket of the tip-pool for user 1. Other examples are also possible.

In the (ii) percentage of sales contribution, the server 106 can identify resource data that includes a net sales amount. The net sales amount of a purchase in a restaurant can equal the gross sales minus the combination of customer discounts and customer refunds. For example, a restaurant sells a breakfast burrito for $9 and the customer applies a $2 coupon when paying for the breakfast burrito. The $7 or $9 gross sale minus the $2 coupon discount is the net sales. The server 106 can then contribute a percentage amount of the net sales that were accrued for the duration of that time punch.

Continuing with the net sales example above, the waiter may have worked the morning shift from opening to 12:00 PM. During the waiter's morning shift at the restaurant, the waiter may have earned net sales of $15.99 from one bill, a net sales of $20.01 from a second bill, and a net sales of $30.45 from a third bill, to name a few examples. Then, the server 106 can apply a percentage amount of the total net sales bill that was accrued during the duration of the waiter's morning shift to a particular bucket of the specific pool. For example, the server 106 may identify a net sales percentage for the user to be 65%, which can be based on a role, seniority, and other characteristics of the particular employee. The server 106 can multiply the total net sales amount of $66.45, e.g., $15.99+$20.01+$30.45, by the net sales percentage of 65%. This results in a scaled net sales value of $43.19. Consequentially, the server 106 can store the scaled net sales value of $43.19 in the a bucket for the corresponding tip pool, e.g., a first bucket that stores the accumulated tips for the user associated with the tipping pool.

In some implementations, the server 106 can receive criteria from a user defining distribution criteria for a tipping pool. The distribution criteria can include defining which roles, e.g., people or employees, departments receive a portion of the allocated resource data in a specific bucket from the resource pool. Moreover, the distribution criteria can define the type of distribution to be performed for a specific resource pool. The type of distribution can include, for example, an equal distribution method, a point distribution method, and a percent distribution method. In some implementations, a specific resource pool is associated with a single distribution method. In some implementations, if a specific resource pool is a cascaded resource pool, then the cascaded resource pool may include more than one type of distribution method.

In some implementations, the equal distribution method can include a method for distributing tips from a particular bucket of a resource pool to users associated with the resource pool. In the equal distribution method, the server 106 can distribute the tips from a particular bucket of a resource pool to users associated with the resource pool in an equal manner. In some examples, the server 106 can distribute an equal portion of the allocated tips in the bucket to each of the users associated with the resource pool. In this example, if three users are associated with the resource pool, the server 106 can distribute a distribution of 33.3% to each of the users.

In some examples, the server 106 can distribute a portion of the allocated tips in the bucket to each of the users associated with the resource pool according to their hours worked. In this example, the server 106 can first determine an equal portion of the tips in the bucket. Then, the server 106 can adjust each user's equal divided portion by their hours worked for that duration. For example, if two users worked 2 hours in an 8-hour period and another user worked 6 hours, then the two users will have their equal portion multiplied by a factor of 2/8, while the user who worked for 6 hours will have their equal portion multiplied by a factor of 6/8. The server 106 then delivers the adjusted portion to each user, accordingly.

In some implementations, the percentage distribution method can include a method for distributing tips from a particular bucket of a resource pool to users associated with the resource pool. In the percentage distribution method, the server 106 can distribute the tips from a particular bucket of a resource pool to users associated with the resource pool according to their designated role distribution or designated department distribution. In some examples, the server 106 can determine a percentage that is associated with a designated role distribution or a percentage that is associated with a designated department distribution. The server 106 can distribute the tips in the bucket according to the percentages for a role or department distribution.

In some examples, in the percentage distribution method, the server 106 can distribute the tips from a particular bucket of a resource pool to users associated with the resource pool according to their designated role/department distribution and hours worked. In this case, the server 106 can determine a percentage that is associated with a designated role/department distribution. Additionally, the server 106 can identify hours worked by each user that contributes to the resource pool. In this case, the server 106 can distribute the tips in the bucket according to the percentages for a role or department distribution and the hours worked by each user. For example, a chef may be assigned 80% for a role distribution, and a waiter may be assigned 20% for a role distribution. Then, when the tips have been accumulated in the bucket, the server 106 can multiply the accumulated tips in the bucket by 80% and the accumulated tips in the bucket by 20%. Then, the server 106 can divide the resultant multiplication value by the hours worked for the chef and the waiter.

In some examples, the server 106 can determine a percentage of the tips contributed by each of the user for the percentage distribution method. For example, user 1 may have contributed 75% of the tips to a bucket in the resource pool, user 2 may have contributed 10% of the tips to the bucket in the resource pool, and user 3 may have contributed 15% of the tips to the bucket in the resource pool. In response, the server 106 can distribute 75% of the tips to user 1, 10% of the tips to user 2, and 15% of the tips to user 3.

In some implementations, the point distribution method can include a method for distribution tips from a particular bucket of a resource pool to users associated with the resource pool. In the point distribution method, the server 106 can distribute the tips from a particular bucket of a resource pool to users associated with the resource pool according to specific ratios assigned to various user roles. The restaurant manager, for example, can configure specific ratios for the point distribution method with the server 106. For example, the restaurant manager can configure that a waiter receives $1 in tips to every $3 in tips a chef receives to every $1.50 that a sous chef receives to every 0.75 cents that janitorial staff receive. In this example, the ratio of chef tips to waiter tips is 3:1 and the ratio of janitorial staff to sous chef is 2:1. In some examples, the restaurant manager can configure that each of the waiter to chef to sous chef to janitorial staff receives the same 1 to 1 tip amounts. In this example, the ratios between each of the employees that contribute to the tip-pool are 1:1. Other examples are also possible.

In some implementations, a resource pool is associated with a single distribution method. For example, server 106 can set a resource pool's distribution method according to one of the equal distribution method, a percentage distribution method, and a point distribution method. The server 106 can receive instructions from a user, e.g., restaurant manager, to set a particular distribution method for a resource pool. In some examples, the server 106 can recommend a particular distribution method for a resource pool to the restaurant manager based on analytics that identifies previous distribution methods used for a similar resource pool type. In some examples, the server 106 can recommend a particular distribution method for a resource pool to the restaurant manager based on analytics that identifies previous distribution methods user for users associated with the resource pool.

In some implementations, a resource pool can include more than one type of distribution method when the resource pool is a cascaded resource pool. For example, server 106 can set a resource's pool distribution method according to one or more of the equal distribution method, a percentage distribution method, and a point distribution method. The server 106 can receive instructions from a user, e.g., restaurant manager, to set a particular distribution method or multiple distribution methods for a cascaded resource pool. In a cascaded resource pool, the output distribution of the resource pool can be fed as an input contribution to a subsequent resource pool. This process can repeat for a number of resource pools. Similarly, the last resource pool can be distributed to the users associated with the cascaded resource pool according to the distribution method associated with the final resource pool of the cascaded resource pool. A cascaded pool may be useful in the event that, for example, a bartender can tip out to waiters, hostesses, or other employees at a restaurant.

In some examples, the server 106 can recommend distribution methods for each resource pool of the cascaded resource pool. The server 106 can recommend distribution methods for each cascaded resource pool based on analytics that identifies previous distribution methods used for users associated with the resource pool and analytics that identifies previous distribution methods used for the resource pools. In some examples, the server 106 can recommend a first distribution method of equal distribution for a first resource pool, a second distribution method of equal for a second resource pool whose input connects to the output of the first resource pool and whose output connects to the input of a third resource pool, and a third distribution method of point distribution method for the third resource pool whose input connects to the output of the second resource pool. The user, e.g., restaurant manager, can select whether to proceed with the recommended distribution methods or select different distribution methods for each of the resource pools of the cascaded resource pool.

In some implementations, the server 106 can generate a report that delineates an amount of tips each individual associated with a resource pool should receive. The report can include, for example, hours worked by each individual, date of work performed for each individual, location of work for each individual, day part for each individual, amount of tips contributed by each individual, and amount of tips delivered to each individual. The report can also include data that identifies the resource pool, the buckets, and the buckets where the distributed tips were pulled. For example, the report can include data identifying a resource pool associated with each individual, e.g., such as a resource pool identifier, a number of buckets and data identifying each of the buckets in the resource pool, data identifying which buckets were used for the distribution, and data identifying whether the resource pool is a single resource pool or a cascaded resource pool.

Similarly, the report can include data that describes the roles able to contribute to the resource pool, the contribution rules associated with the resource pool, the distribution rules associated with the resource pool, and any other criteria designated for the specific resource pool. The report can also include data provided by the user when submitting the tipping information. This data can include, for example, accumulated sales data, accumulated tips, and accumulated net sales data. The report can also specify the labor data and can show in specificity, accrued tips according to time punches, hours worked, shifts of time worked, and indications whether a user is contributing to multiple resource pools.

In some implementations, a user who configured the resource pool can review the results of the report. The server 106 can print the report, email the report to a client device of the user, e.g., the restaurant manager, display the report on a display screen of the server 106, and send the report as a text message to a client device. The restaurant manager can review the report to identify any discrepancies in the report. The discrepancies can include, for example, errors during the configuration of roles of users for a specific during the creation of the resource pool, errors identified in tip calculations, errors identified in user account information for distributing the tips, and other errors related to the configuration and implementation of the resource pool.

In some implementations, the server 106 can seek to identify whether double counting has occurred in response to generating the report. In some cases, a user may be assigned to multiple tipping pools and the server 106 can ensure that the user is contributing close to if not equivalent to 100% of all their submitted tips to each of the bucks across the multiple tipping pools. However, issues can occur if the server 106 accidentally errs and contributes more than 100% of a user's tips to one or more buckets across the multiple tipping pools.

In this example, the server 106 can initiate a process to identify a cause for the double counting issue. For example, the server 106 can initiate the process to identify the cause of the double counting by traversing a graph of users and their corresponding tip contribution. The server 106 can tag each tip contribution for a user and sum each tip contribution for the user. When the sum for each tip contribution for a user exceeds 100% of a reported tip earnings amount, the server 106 can seek to identify a tip or tips that push the overall total tip contribution to be greater than 100%. In response to identifying a tip or tips that push the overall total tip contribution to be greater than 100%, the server 106 can remove or correct the tip contribution accordingly. For example, the server 106 may automatically report the identified error to the restaurant manager and request one or more actions for the restaurant manager to select to correct the issue. In some implementations, the server 106 can automatically correct the issue and report the identified error and the action taken to correct the issue to the restaurant manager for their review.

System 100 illustrates a variety of data sources 102-1 through 102-N (hereinafter “data sources 102”) that communicate with server 106 over a network 104. In some examples, the data sources 102 can include devices in which customers can enter tips or other resources when paying for service at a service provider. The data sources can include, for example, POS systems, mobile devices with their applications, a personal computer, a handheld device, a portable device, a tablet, an embedded microprocessor device, and other devices. The data sources 102 can also include a server, multiple servers, and other devices that act as standalone devices and communicate with the server 106 over the network 104. In some examples, the data sources 102 may communicate with the server 106 through a different data source or client device.

In some implementations, the server 106 can include one or more computers connected locally or connected over a network. Additionally, the server 106 can include one or more data storage components to store resource data, historical resource data, employee information, configuration and distribution information, and other information related to a resource-pooling engine. For example, the server 106 can include data storage components and can include one or more databases, the cloud, one or more solid-state drives, hard drive disks, and other storage components. The server 106 can communicate the data sources 102 and other data sources over network 104. The network 104 can include, for example, a local network, such as Bluetooth, Wi-Fi, or a larger network, such as the Internet, to name a few examples. Alternatively, a user may directly interact with the server 106 by way of a touchscreen, a monitor, a keyboard and a mouse, or some other form of interaction with the server 106.

In some implementations, the server 106 may communicate with various databases. The various databases can store information for identification and tracking of data sources 102, as well as other data sources, as well as for tracking resource data and corresponding labor data from the data sources 102. The server 106 can poll the data sources 102 on a periodic basis, e.g., every hour, every two hours, every day, once a week, or other, for the resource data and the corresponding labor data.

In some implementations, the server 106 can receive the resource data and the corresponding labor data from each data source 102 in response to a customer entering data into the data source 102. For example, when a customer applies a tip when paying for a bill, the customer applies the tip by performing a payment, such as an electronic payment with the data source, e.g., data source 102-1. The data source 102-1 can then transmit resource data, e.g., sales receipt data that includes tips, and labor data to the server 106 over the network 104 in real time in response to receiving the payment from the customer. In some examples, the data sources 102 can store the payment and hold the payment until the end of the day and transmit the accumulated resource data and corresponding labor data to the server 106 at the day's end. In some examples, the data sources 102 can transmit accumulated resource and labor data to the server 106 on other intervals, e.g., every minute, every hour, every few hours, and so on.

System 100 illustrates multiple data sources 102 communicating with the server 106 over network 104. Specifically, each of the data sources 102 may be located at different geographic regions. For example, data source 102-1 may be located in a restaurant in New York City; data source 102-2 may be located in a restaurant in Montreal, Canada; and data source 102-N may be located in Munich, Germany. Despite being located in different locations, the data sources 102 can transmit resource and labor data to the server 106 over network 104 in real-time.

System 100 illustrates how a particular data source is used when receiving payment for goods or service. Continuing with the example from above, data source 102-1 may be located in a restaurant in New York City and a waiter may server customers food and drink. After the customers have finished consuming their food and drink, the customers can pay for the bill and provide a tip. As illustrated, the waiter can thank the customers-“Thanks for the $15 tip!” In some examples, the customers can pay for the bill and provide the tip to the data source 102-1. In response, the data source 102-1 can receive the bill and tip and generate data 105-1 to transmit to the server 106. The data 105-1 can include resource data and corresponding labor data for one or more transactions performed with the data source 102-1.

For example, the data 105-1 can include resource data, which describes the transaction payment, and labor data, which describes a time punch or hours worked for the employee. The labor data can include, for example, a merchant name, a merchant location, hours worked, merchant category, data source identifier, which role worked on the time punches, which department worked on the time punches, and employee identifier. The resource data can include, for example, a sales amount, a new sales amount, a tip amount, a timestamp that includes the date, accumulated sales over hours worked, accumulated tips over hours worked, and other data related to transactions.

Similarly, the data sources 102-2 and 102-N, which may be located in restaurants in Montreal, Canada and Munich, Germany, respectively, can accept transaction payments from customers. For example, a bartender at a restaurant in Montreal can serve one or more drinks to his customers and receive payment along with a tip. As illustrated, the bartender can thank the customers-“Thanks for the $10 tip!” Similarly, another waiter located at a restaurant Munich, Germany can serve food to his customers and receive payment along with a small tip. As illustrated, the waiter can obligingly thank his customers for the small tip-“Thanks for the $1 tip.” In some examples, the restaurant in New York City may include more than one data source, e.g., data sources 102-1, 102-3, and 102-4, and each of these data sources may communicate data 105-1, 105-3, and 105-4, respectively, to server 106 over network 104.

In some implementations, multiple customers can interact with a single data source at a particular location. For example, a chef, a waiter, a bartender, and a hostess may each provide their customers with the ability to enter payment information into data source 102-N at the restaurant in Munch. In some examples, the chef, waiter, bartender, and hostess may each utilize different and/or separate data sources for their customers to provide payment information. Then, each of the data sources 102 can transmit the data 105 to the server 106.

Generally, when an employee utilizes a data source, such as data source 102-2, the data source can request for identification information so the data source 102 is aware of the identification of the employee. For example, the employee may be requested to enter their employee identifier or a user name and password for identification. The data source may map the authenticated user name and password to an employee identifier known by the data source 102. The employee identifier is then subsequently sent in the labor data of data 105 to server 106 over network 104 by the data source in response to the employee enabling a customer to provide a payment transaction with the corresponding data source. When the server 106 receives the data 105 from the data source, the server 106 can extract the employee identifier to identify an internal identifier that maps to the employee identifier. Similarly, the data source may request the employee to enter their role, e.g., chef, waiter, host, hostess, etc., hours worked, data indicating which shift was worked, data indicating whether the employee decides to opt in or opt out of utilizing a tipping pool, banking information for the employee for paying out the tips, and other information. The data source can generate data 105 that includes this information entered by the employee and other data identified by the data source 102.

In some implementations, the employee can enter in declared tips into the data source 102 at the days end. For example, the employee can manually input the declared tips that may have been received as a cash tip. At the end of the day, the employee can clock out from their shift by entering a specific number of declared tips that were accrued through their work period. As such, the declared tips may be a separate portion of the resource data than sales information paid for by the client with their credit card, debit card, or smart phone, to name some examples.

The data 105 can be, for example, an email, a text message, an attachment, a compressed file, CSV file, or other file types used for transferring from the data source 102 to the server 106 over network 104. In some examples, each data source 102 may communicate their respective data 105 using their own form of proprietary information. The proprietary information can include, for example, a specific frame structure, a specific bit or byte pattern, an encryption method, a handshake agreement, a specific transportation protocol, a formatted application programmable interface (API) method for accessing the data 105, or another manner for formatting the data 105.

Before the server 106 can receive and extract the contents of data 105 from a respective data source, the server 106 can request for data that indicates the proprietary information from each of the data sources 102. For example, the server 106 may transmit a request to each of the data sources 102 for the proprietary information and receive the proprietary information from each data source 102 in response. In some examples, the server 106 may receive the proprietary information from a user that creates the resource pool. The user may provide data related to the resource pool and the proprietary information related to the data sources 102 the users associated with the resource pool will use to provide resource data, e.g., payment transactions, sales data, tipping, etc. In this manner, when the server 106 obtains the data 105 from a respective data source, the server 106 can perform a normalization process according to the proprietary information associated with the corresponding data source.

As mentioned, each of the data sources 102 can communicate with the server 106 using their own proprietary information, e.g., protocol or specified communication mechanism, and can transmit data 105 in a manner known to the device. For example, an employee of a coffee shop can input the resource data to the disparate device and the disparate device can transmit the data 105 to the server 106 over network 104. As illustrated in system 100, the server 106 can receive the data 105 from each of the disparate data sources 102 during (108).

In some implementations, the server 106 can wait to proceed processing the data 105 from each of the disparate data sources 102 until a predetermined time has elapsed. In some examples, the server 106 can initiate processing the data 105 in response to an end of a work day for the service associated with the data source that transmitted the data 105. In this example, the server 106 can wait to process the data 105 until it has received all resource data for a particular duration at the service. The particular duration may include, for example, a day part time period, a shift time period, or another time period, to name some examples. This particular duration may be configurable by a user, e.g., restaurant manager that configured the corresponding resource pool. In some examples, the server 106 can initiate processing the data 105 in response to receiving the data from a particular data source, e.g., data source 102-1.

During (110), the server 106 can normalize the received data 105 to a similar format. The server 106 can normalize the received data 105 by (i) identifying a type or which of the data sources 102, e.g., such as data source 102-2, transmitted the data 105 and (ii) performing a corresponding normalizing function on the received data 105 based on the identification of the type of data source 102. Specifically, based on the type of the data source 102 that transmitted the data 105, the server 106 can apply one or more algorithmic functions or rules to normalize the received data 105 to a format understood by the server 106. The server 106 can identify the type of normalization functions to apply based on an identification of the data source 102 that transmitted the data 105. For example, the server 106 can determine from the data 105 the data source 102 based on identifying a pattern in the data 105, identifying a code in the data 105 that identifies the data source 102 and is uniquely identifiable across all data 105 from each of the data sources, or identifying a timing slot in which the data 105 was received, which indicates to the server 106 which data source 102 transmitted the data 105. Other examples are also possible.

In response to identifying the type of data source 102 that transmitted the data, the server 106 can apply one or more algorithmic functions or normalization functions according to the type of data source 102. These functions enable the server 106 to, for example, recognize the payload of the data 105, recognize the headers, decrypt the data 105 with a particular key, unscramble the data 105 according to a scrambling algorithm, or some other software algorithm. In some examples, with the identified algorithm functions, the server 106 can convert the received data 105 to a frame structure that includes various payload components. In some examples, the server 106 can translate the received data 105 to various data items that specify resource data and corresponding labor data for a particular employee and/or for multiple employees. The specified resource data and corresponding labor data may be specific to a particular employee or multiple employees over a specific time period, e.g., a morning or night shift, at a particular service location, e.g., a restaurant in Washington, D.C., or a cafe in New York City.

In response to normalizing the resource data to a format understood by the server 106, the server 106 can extract the resource data from the normalized data 105. The extracted resource data can include the data relevant to one or more payment transactions associated with a particular data source, e.g., data source 102-1. During (112), the server 106 can perform an indexing function with the extracted resource data. As previously mentioned, each resource data extracted from data 105 includes a user identifier. The user identifier may be a user identifier such as “USERID0000” that identifies the user who enters the payment transaction into the data source. The server 106 can identify an internal identifier using the user identifier extracted from the normalized data 105.

In some implementations, the server 106 can perform one or more processes to identify users worked from the resource data extracted from the normalized data 105. These processes may include identifying users or roles from mapping. Specifically, when an admin or manager, e.g., restaurant manager, configures a user or role for an employee with a particular data source, the manager can provide that information to the server 106. This information can be provided in the form of an identifier, e.g., user identifier. Thus, when the server 106 receives data 105 and extracts resource data from the data 105, the server can perform inferences to determine who the tips should be contributed to for a particular time period. For example, the server 106 can identify from the resource data user identifiers and corresponding time stamps. Then, the server 106 can identify which user worked during that time period and seek to identify a corresponding labor data, e.g., time punch data, that worked under the same user and where the resource data, e.g., sales receipt, falls under the same time punch data. The server 106 can accumulate the sales data for the identified user and identify the internal identifier for the identifier user.

The server 106 can access the mapping of identifiers in its database. As mentioned, the mapping of identifiers can store the mapping of the user identifier to the internal identifier for a particular resource pool. The server 106 can identify an internal identifier from the user identifier according to the mapping. For example, the server 106 may identify an internal identifier of “X(#KSDN” from the mapping of the user identifier of “USERID0000”. In response to identifying the internal identifier, the server 106 can store the resource data and the corresponding labor data in the database according to the internal identifier, e.g., such as by way of an index in the database. The server 106 can perform this process of storing extracted resource and labor data from the normalized data 105 for each data 105 transmitted by a particular data source. Consequentially, the server 106 can store large portions of resource data and corresponding labor data in the database and maintain tracking of the resource data and corresponding labor data for individual employees over large portions of time.

In some implementations, the server 106 can store data that identifies which corresponding internal identifiers corresponding to which specific resource pool. As such, the server 106 can access data that identifies the specific resource pool using the identified corresponding internal identifiers. Here, the server 106 can determine how to allocate the extracted resource data to one or more specific buckets of a corresponding resource pool. For example, the database can store the following data indexed by the internal identifier: the specific resource pool the user or role can contribute to and receive distributions from, contribution criteria for a specific resource pool for the user, distribution criteria for a specific resource pool for the user, resource data for the user, labor data that corresponds to the resource data for the user, user identifier information, mapping information between the internal identifier and the user identifier, and timestamp information associated with the resource data.

The server 106 can allocate the indexed resource data to one or more buckets of a specific resource pool according to various criteria. For example, in response to identifying the resource data that corresponds to a user and to identifying the internal identifier that corresponds to that user, the server 106 can identify which specific resource pool to attribute the resource data. Each resource data component has a corresponding labor data component. As such, the labor data component tells the server 106 for which time period worked does the resource data correspond. The server 106 can analyze the labor data, e.g., the time punch data, to determine a time period that corresponds with the hours worked for the employee. Using the time period, the server 106 can identify which specific resource pool the corresponding resource data belongs.

For example, the server 106 may determine that a user with a user identifier of “USERID1111” and a corresponding internal identifier of “019838u” submitted resource data and corresponding labor data from a data source 102-1. The server 106 can determine that this user has access to two different resource pools—a first resource pool for a morning shift day part, e.g., opening to 12:00 PM, and a second resource pool an afternoon shift day part, e.g., 12:00 PM to closing. Each of the first resource pool and the second resource pool has three separate buckets—a first bucket that stores accumulated tips for the user, a second bucket for resource data that does not belong to any contribution roles for the resource pool, and a third bucket for resource data in which the server 106 is not able to identify a role for the labor data or the server 106 was not able to identify the labor data for any of the roles.

Continuing with this example, the server 106 can determine contribution rules for the user and distribution rules. For the contribution rules, the user can be set up for equal contribution for both the first resource pool and the second resource pool according to the database information indexed by the internal identifier. For the distribution rules, the user can be set up for percentage distribution for both the first resource pool and the second resource pool according to the database information indexed by the internal identifier. The server 106 can identify three separate transactions in the extracted resource data and corresponding labor data. A first transaction can include a tip of $5.00 during the hours worked between 8:00 AM and 11:00 AM, a second transaction can include a tip of $6.00 during the hours worked between 11:00 AM and 1:00 PM, and a third transaction can include a tip of $4.00 during the hours worked between 4:00 PM and 7:00 PM.

During (114), based on the identified resource pools, the contribution rules, the distribution rules, and the transactional information, the server 106 can determine how to allocate these transactions to buckets of the first and second resource pools. For example, the server 106 can determine that the tip of $5.00 should be attributed to the first resource pool since that tip was earned during the morning shift, e.g., worked from 8:00 AM to 11:00 AM which falls in between the opening to 12:00 PM criteria of the first resource pool. Second, the server 106 can determine that the tip of $6.00 should be split evenly between the first resource pool and the second resource pool because that tip was earned during one hour on the morning shift and one hour in the afternoon shift, e.g., worked from 11:00 AM to 1:00 PM which falls on one hour for both the morning and afternoon shifts. Third, the server 106 can determine that the tip of $4.00 should be attributed to the second resource pool since that tip was earned during the afternoon shift, e.g., worked from 4:00 PM to 7:00 PM which falls in between the 12:00 PM to closing criteria of the second resource pool. In some examples, the server 106 can allocate these transactions to buckets of the first and second resource pools according to the contribution rules defined for each user.

In some implementations, the server 106 can gather accrued tips for a given period and sales receipts for the given period. In response, the server 106 can infer which user or users worked a specific role according to the accrued tips and the time punches. Specifically, the server 106 can perform a real time inference on the sales tips, relate the sales tip back to time punches to get an accurate account of the individual tip amounts over all the sales receipts that were accrued for the period. The server can perform this tip allocation process by gathering the time punches worked under the location for that given time period, gather the sales receipts that were accumulated through the time period for that location, and perform inference on the time punches so that the time punches are worked under a specific role. As such, the server 106 can filter out the time punches that were not worked within a typical time period. This filtering ensures that the server 106 does not contribute tips that are not related to the tip-pool and the server 106 does not double count tips for one or more roles.

Additionally, in this example, the server 106 can determine that the user declared tips during the opening to closing time period. Since declared tips represent a one-time representation of a summary of all cash tips that were accrued during that period, the server 106 can determine how to contribute the declared tips to the first resource pool, the second resource pool, or both. In some examples, the server 106 can contribute or allocate the declared resource tips according to a proportion of hours worked. In this example, since the user worked from 8:00 AM to 7:00 PM and the restaurant is open from 8:00 AM to 7:00 PM, the server 106 can distribute 50% of the declared tips to the first resource pool and 50% of the declared tips to the second resource pool. In some examples, if the user worked from 11:00 AM to 7:00 PM and the user declared $100 in tips, then the server can adjust the declared tips according to hours worked. In this example, since the user worked 8 hours and the hours worked crosses both the morning and afternoon shift, ⅛ of the $100 tip or $12.50 can be applied to the first resource pool, e.g., which is associated with the morning shift, and ⅞ of the $100 tip or $87.50 can applied to the second resource pool.

In some implementations, the server 106 can split the declared tips using other processes. For example, the server 106 can split the declared tips according to different resource pools based on percentage of sales or percentage of tips over these different day parts. For the percentage of sales, if the server 106 determines that the user's resource data indicates that the percentage of sales for the morning shift is 75% greater than the percentage of sales for the afternoon shift, then the server 106 may attribute 75% of the declared tips to the first resource pool, e.g., associated with the morning shift, and 25% of the declared tips to the second resource pool, e.g., associated with the afternoon shift. For the percentage of tips, if the server 106 determines that the user's resource data indicates that the percentage of tips is 30% greater in the morning then in the afternoon, then the server 106 can attribute 65% of the declared tips to the first resource pool, e.g., associated with the morning shift, and 35% of the declared tips to the second resource pool, e.g., associated with the afternoon shift.

In response to the server 106 determining which resource pool the tips or resource data are to be allocated, the server 106 can determine which bucket of the resource pool that each tip should be deposited. The server 106 can then use the buckets at a later point in time for distributing the tips to the users. For example, the first resource pool may include three buckets. The first bucket can represent a bucket that stores tips that belong to the tip pool, and those tips include sales receipts that the server 106 can associate with time punches that were worked for role that is configured for this specific tip pool. In some implementations, the server 106 can contribute the tips to the first bucket according to the contribution rules created for the specific user.

The second bucket can represent a bucket that should not be contributed to the tip pool, e.g., first bucket, so the server 106 associated these tips to a time punch that was confirmed to work under a specific role that does not belong to any contribution rules in the tip pool. The second bucket can have its tips discarded or saved for later distribution since they are not associated with the tip pool. The third bucket can represent a bucket of unassigned tips. The third bucket of unassigned tips include (i) tips that can be associated to a time punch that no role worked so the server 106 contributes these as unassigned and (ii) tips that the server 106 could not associate to any time punches. In some examples, tips that are assigned to the third bucket can be caused by errors. These errors can include, for example, errors caused due to mapping by the manager when setting up the tip pool, errors with the data sources 102, or other errors.

During (116), the server 106 can aggregate and distribute the portions of the allocated resource data in the buckets from each resource pool according to distribution criteria. For example, as mentioned, the distribution criteria can include which roles, e.g., people or employees, departments, exclusion of people based on roles, are to receive a portion of the allocated resource data in a specific bucket from the resource pool. Moreover, the distribution criteria can define the type of distribution to be performed for a specific resource pool. The type of distribution can include, for example, an equal distribution method, a point distribution method, and a percent distribution method. The server 106 can accumulate the tips or resource data from these buckets and distribute the tips to various devices or bank accounts associated with the users that use the resource pool.

In some implementations, a manager can designate a distribution method for the tips in the second bucket. The tips in the second bucket can be, for example, distributed to users who do not contribute to the tip pool, e.g., janitorial staff, distributed to a different tip pool, e.g., a cascaded pool, and remain untouched until a manager reviews these tip amounts and determines which user/role/departments should receive these tips in the second bucket.

In some implementations, a manager can designate a distribution method for the tips in the unassigned bucket. The tips in the unassigned bucket are not contributed to the tips bucket, and as such, are not considered to be distributed to the users that use the resource pool. In some examples, these tips may be provided to the department of the service or held until a manager reviews these tip amounts and determines which user/role/departments should receive the unassigned tips.

In response to aggregating and distributing tips, the server 106 can generate a summary report that delineates an amount of tips each individual associated with a resource pool should receive. For example, the summary report can indicate that for a specific resource pool, employee A receives $25.50 in tips, employee B receives $30.00 in tips, and employee C receives $15.00 in tips. Moreover, the server 106 can generate a traceability report. The traceability report enables a manager to review the process by which the tips were received by the server 106 and distributed to the bank accounts of the users. This process can include, for example, any of the processes related to (108)-(116). A manager can review this traceability report to determine whether errors exist in the aggregation of resource data, normalization of the resource data, indexing and storing of the resource data, determining the contribution rules and the contribution of allocated resource data to one or more buckets of the resource pool, and determining the distribution rules and the distribution of the tips from the one or more buckets of the resource pool.

In some implementations, the server 106 can also generate a data file which can be submitted to payroll. The data file can include, for example, a generated report, a CSV, or an XML file, that describes the information from the summary report and the traceability report. The server 106 can transmit the data file to a payroll third-party company that can use the data file as a means to validate payroll information for one or more users. In response to validating the payroll information for the one or more users, the payroll may transmit payment information to the employees using the tipping distributions from the data file.

FIG. 1B is a flow diagram 101 that illustrates an example of resource pooling aggregation and distribution. The flow diagram 101 can be performed by the components of system 100. For example, the data sources 102 and the server 106 can perform the processes of the flow diagram 101. FIG. 1B illustrates various operations shown in various stages which can be performed in the sequence indicated, in another sequence, with fewer stages, or with additional stages.

At 118, an employee can charge a customer for a service performed. For example, the employee may be a waiter who charges a customer for eating appetizer, dinner, and dessert at a restaurant. The waiter can provide a data source that records electronic payment made by the customer for the performed service. Similarly, the customer can pay for the service and/or provide an additional tip at the discretion of the customer in cash. Moreover, the customer can provide cash tips. The employee can input the declared tips into the data source.

For example, at 120, the data source can include a POS device, a mobile device, a computer device, a tablet, a handheld device, or another device. The database shown at 120 can include data that identifies each of these data sources. The data can include, for example, a telephone number, a MAC address, an IP address, a hostname for the device, data identifying the type of the data source, an identifier of the data source, a location where the data source is utilized, and other identifying information. Users, such as employees and customers, can interact with these data sources and the data sources can transmit data, e.g., resource data and corresponding labor data, to a server, such as server 106.

At 122, the server 106 can include a tip-pooling engine. The tip-pooling engine can include one or more algorithmic processes that perform the functions identified in 108-116 of server 106 of FIG. 1A. Specifically, one or more graphical processing units (GPUs), one or more central processing units (CPUs), one or more memory components, and other components can perform the functions of, and be part of, the tip-pooling engine 122. The tip-pooling engine 122 can perform, for example, the processes of aggregating the resource data from a variety of disparate data sources which may be located at different geographical regions, normalizing the resource data received from each of the disparate data sources according to normalizing functions associated with the disparate data sources, allocating the acquired resource data into one or more tipping buckets associated with one or more resource pools according to a predetermined set of contribution rules. Moreover, the tip-pooling engine 122 can also distribute the allocated resource data from each of the tipping buckets to various employees, departments, or roles, based on the amounts contained in the tipping buckets and their corresponding set of rules. The tip-pooling engine 122 can perform the processes described in FIG. 1A with respect to processes 108 through 116, for example.

At 124, the tip-pooling engine can output data indicative of how the distribution amounts was created and the distribution amounts themselves to each of the employees associated with the respective resource pool. At 126, the tip-pooling engine can compile the data indicative of how the distributions were created into a summary report and a traceability report. The summary report can delineate an amount of tips are to be distributed to each individual associated with a resource pool. The traceability report enables a manager to review the processes by which the tips were received by the server and ultimately distributed to the bank accounts of the employees. More specifically, the traceability information can illustrate how the distribution amount was determined by the system, starting from the amount acquired by the system, how the tip amount was applied to one or more buckets, and how the distribution amount for each of the buckets was determined, to name a few examples. In this manner, the manager can determine whether the distribution amount is accurate for each employee. Moreover, should the manager identify any inconsistencies or errors in the system's determination of a distribution amount for one or more employees, the manager can provide feedback to the system to initiate a correction. The feedback can indicate a corrected distribution amount for an employee, a percentage applied from each tip-pooling bucket, a correction to the normalization process, and even, a correction applied to the transmitted resource data from the original device. Other examples are also possible. Consequentially, the feedback process ensures that the employees are properly allocated the correct portion of the available resources based on the characteristics of their worked shift.

At 128, the tip-pooling engine can distribute the portion of tips designated to a specific employee to the specific employee. For example, the tip-pooling engine can send data to a payroll third-party company or another company to determine how and where to distribute the portion of tips designated to the specific employee. Moreover, at 130, the tip-pooling engine can store data indicating tip distributions in a tips database. The tips database can store which employees are to receive tip distributions, which employees are to be excluded from receiving tip distributions, an amount to distribute to each of the employees, and destination accounts for distributing the tips, to name a few examples. The tip-pooling engine and the third-party company can access the tips database to determine where to send tip distributions for an employee and how much tip distributions to send to the employee.

At 132, the tip-pooling engine can track whether an employee has withdrawn tips associated with their tip distribution before payday. Typically, tips are distributed to employees with their paycheck, e.g., such as monthly, bi-monthly, or other. However, in some cases, employees can withdraw their tip distributions before their regularly scheduled payday. This may be the case, for example, when an employee declares tips and pockets the declared tips or when the employee requests for pay in advance for personal reasons. In this instance, the tip-pooling engine can track when an employee withdraws tip distributions early and reflects such withdrawal action in a revised tip report, e.g., revised traceability and summary reports.

The tip-pooling engine can repeat, e.g., 126, 128, 130, and 132, these processes until the tip distribution amount has been satisfied. For example, at 134, the tip-pooling engine can pay the remainder of tips via existing processes or push the remainder of the tips to the third-party payroll company to pay. Specifically, on an employees payday, the third-party company or other company can pay the employee their salary in addition to the distributed tips amount accrued from the tipping buckets of the associated one or more resource pools. At 136, the third-party company or the other company can, for example, deposit the salary and distributed tips in a tips bank account of the employee, mail the employee a check, deliver the salary and distributed tips in cash, add the salary and distributed tips to their retirement account, or another form of payment. The tips bank account can be an account that holds distributed tips and/or salary payment transactions for the employee.

If the employee decides to withdraw their salary and/or distributed tips from the tips bank account by selecting a withdrawal bank account link in their tips bank account, then at 138, the tip-pooling engine can determine whether they have their own personal bank account linked to their tips bank account. If the employee does not have a bank account linked to their tips bank account or is a new employee at the company, e.g., a restaurant, at 146, the employee can enroll their tips bank account with their personal bank account system. The third-party payroll system can enroll the employee with banking information and give the third-party payroll system access to deposit funds, e.g., salary and/or distributed tips, to the employee's bank account through their tips bank account. The employee can be enrolled in the bank account system by providing credentials, e.g., username and password, along with selecting a type of bank account they wish to enroll, e.g., savings account, checking account, investing account, retirement account, or other. Then, at 148, the employee can provide credentials and the selected type of bank account that the tips bank account has access for depositing salary and/or distributed tips. The bank account system may need to verify the authenticity of the employee before enabling the tips bank account system to have access to their personal bank account.

Once the employee enrolls their tips bank account with a personal bank account, at 136, the employee can withdraw funds from their tips bank account and deposit into their personal bank account. The tips bank account information can include an amount of money stored in their tips bank account. The tips bank account information can also include a bank link that enables the employee to withdraw distributed tips from their tips bank account.

Back to 138, now the employee has configured a personal bank account through their tips bank account, the tip-pooling engine can ask the employee how much they want to withdraw from their tips bank account at 140. The employee may indicate, for example, a portion of their salary and/or tip distributions up to a total amount stored in their tips bank account for withdrawal. For example, the employee can indicate $20 out of $100 for withdrawal. In some examples, the employee can also indicate the currency for withdrawal. The tip-pooling engine can receive an indication that the employee wishes to withdraw their currency amounts in euros rather than US or Canadian dollars, for example.

At 142, the tip-pooling engine can convert the currency stored in their tips bank account to the desired currency, and can distribute the converted currency to their personal or employee bank account. In some examples, the tip-pooling engine can distribute the non-converted currency to the personal or employee bank account of the employee from the tips bank account. The tip-pooling engine can distribute an entirety of the tips from the tips bank account to the employee bank account or can distribute a portion of the tips from the tips bank account identified by the employee.

At 144, the tip-pooling engine can note an amount that the employee had withdrawn from their tips bank account into their employee bank account. The tip-pooling engine can store data indicating an amount of salary and/or tips withdrawn from their tips bank account, a date when the amount was withdrawn, and an amount of money remaining in their tips bank account, to name a few examples, in the tips database. Thus, the next time the employee desires to withdraw tips and/or salary from their tips bank account, the amount of cash remaining in their tips bank account can be properly updated to reflect the amount following the withdrawal of tips and/or salary.

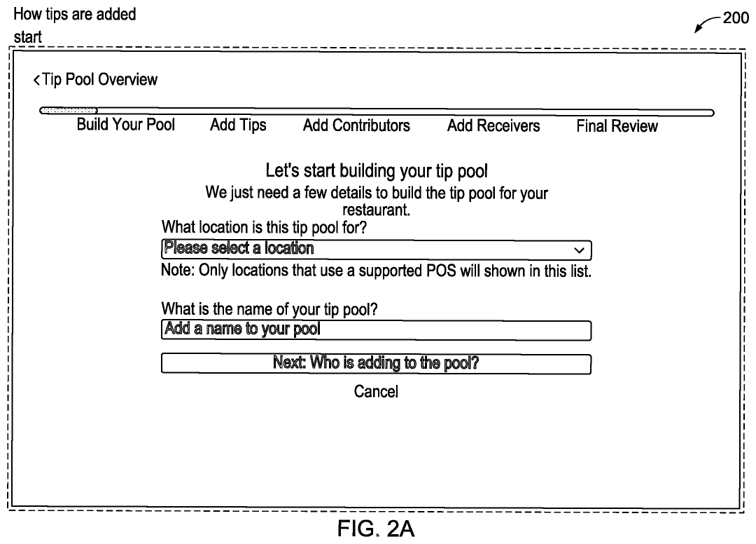

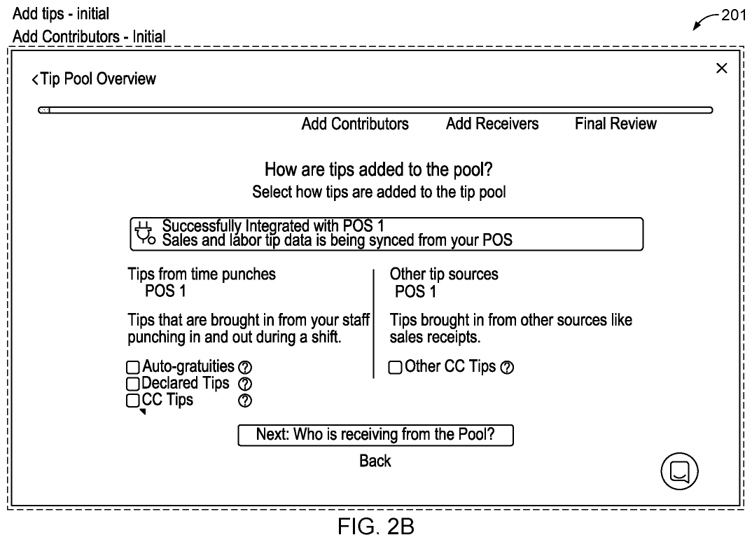

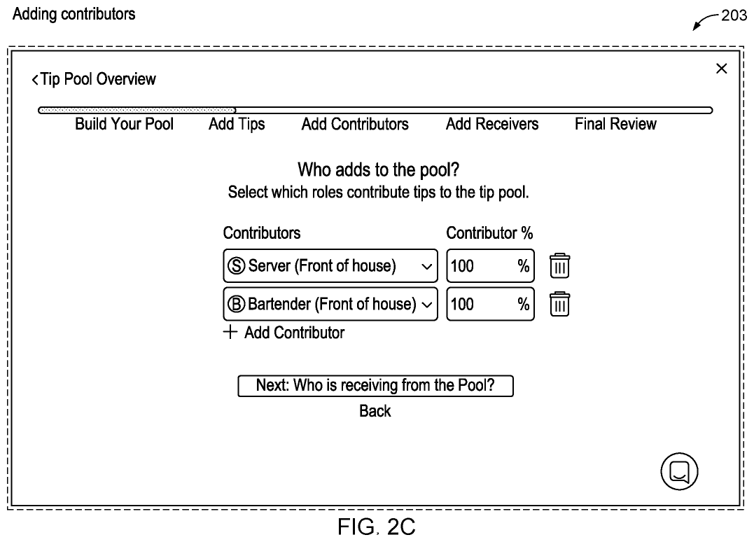

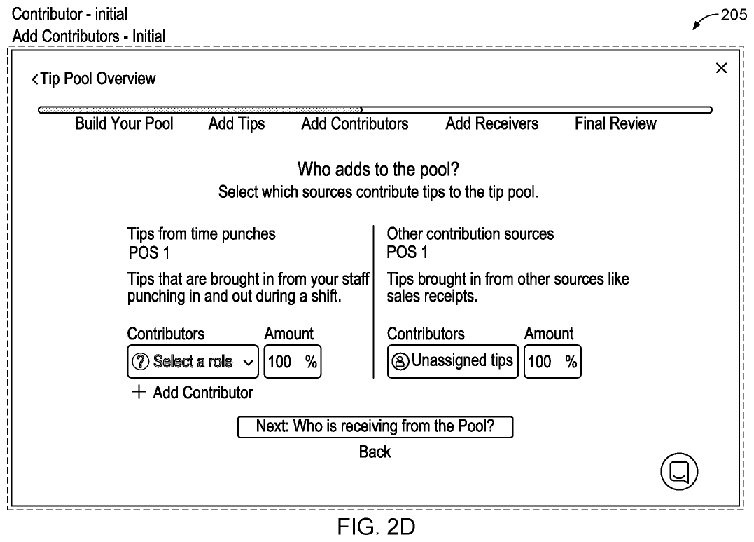

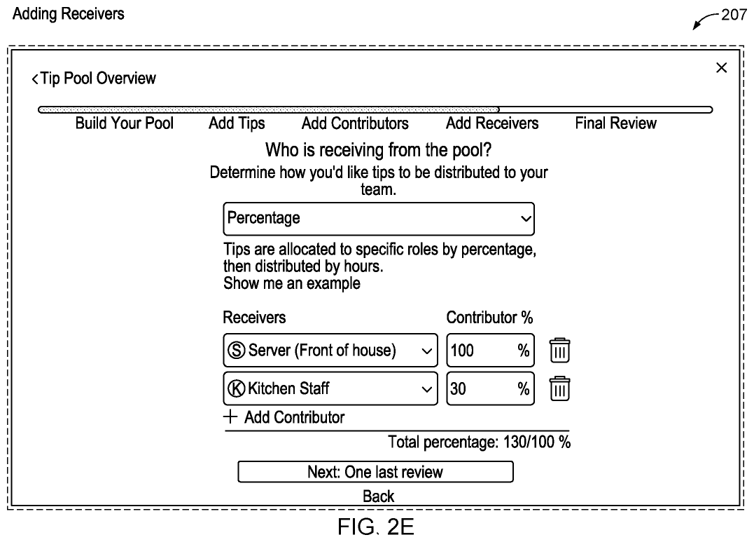

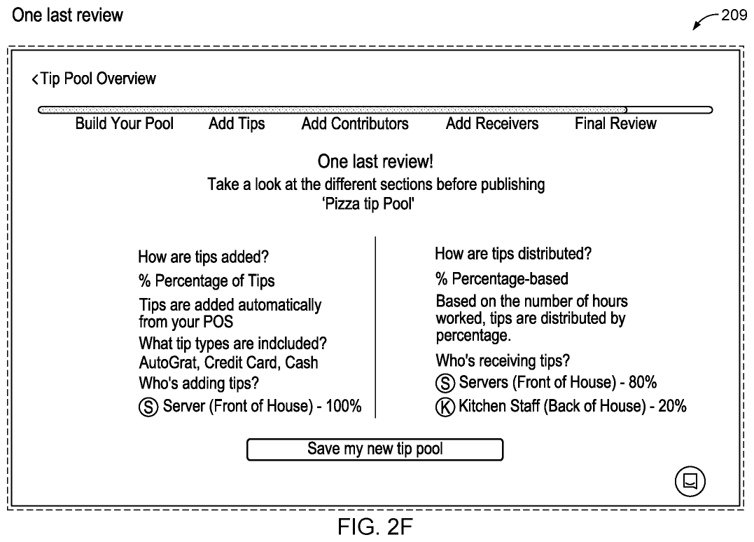

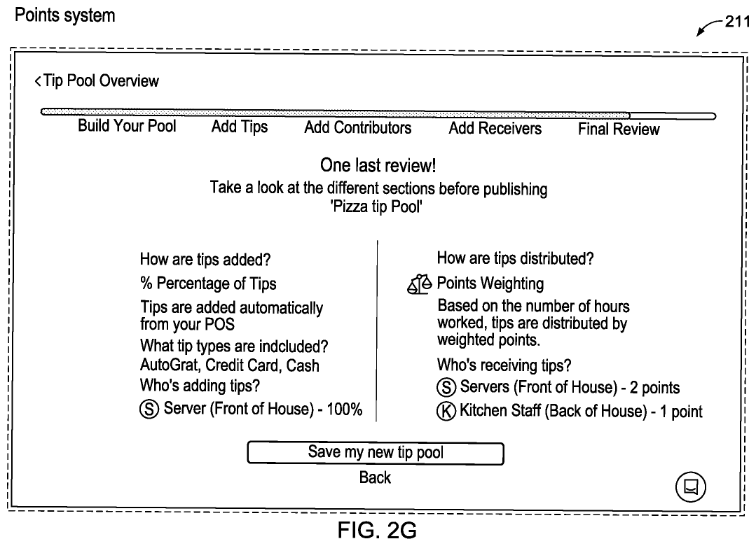

FIG. 2A is an example of a user interface 200 that illustrates the creation of a resource pool for aggregation and distribution. The user interface 200, as well as the user interfaces for FIGS. 2B-2G, can be displayed on a client device or on a monitor connected to the server, such as server 106. A user, such as a manager or admin, e.g., restaurant manager, can interact with the user interface 200, to manage the tipping contributions and distributions for their employees. The user can create the resource pool, set the contribution criteria, the distribution criteria, set the number of buckets within the resource pool, and set various criteria associated with the resource pool.

For example, the user interface 200 displays prompts to the user. The prompts include “Let's start building your tip pool” and “We just need a few details to build the tip-pool for your restaurant.” The user interface 200 requests the user to enter a location for the tip pool-“What location is this tip-pool for?” The user can interact with the user interface 200 to enter the location. The user can, for example, type in a location of a restaurant, the name of a restaurant, or the name of a region of restaurants. In some examples, the user interface 200 can indicate, “Only locations that use a supported POS will show in this list.” As such, if the user enters restaurants or locations that do not have a supported POS device, then the user interface 200 may not allow entry of that restaurant or location. In some examples, the user can enter a restaurant or location that does not have a supported POS device but the POS device may be added at a later point in time.

In some implementations, the user interface 200 requests the user to enter the name of the tip pool. For example, the user interface 200 can display a prompt “What is the name of your tip pool?” The user can enter in a name of the tip-pool by interacting with the user interface 200, e.g., typing, speaking, or tapping on the display of the user interface 200. In some examples, the user can also select tip-pool names that have been previously used in the past from user interface 200.

In response to entering the location of the tip-pool and a name of the tip pool, the user can interact with the button on user interface 200 to proceed to the next interface. For example, the button on user interface 200 may become activated in response to successful entry of tip-pool location and tip-pool name. The button can display, for example, text that indicates “Next: Who is adding to the pool?” The user can interact with the button and proceed to the next interface.

FIG. 2B is an example of another user interface 201 that illustrates the creation of a resource pool for aggregation and distribution. User interface 201 is a continuation of user interface 200. Specifically, in response to the user interacting with the button on user interface 200 to proceed to the next interface, user interface 201 is displayed on the client device.

The user interface 201 can indicate that the user selected a POS device that is successfully integrated with the server. For example, user interface 201 can display “Successfully Integrated with POS 1—Sales and labor tip data is being synced from your POS.” The user can then select options related to tips to be added to the tip pool. For example, the user can select options related to (i) tips being acquired from time punches and (ii) other tip sources. For (i), the user can select options for tips that are brought in from staff or employees clocking in and clocking out of a shift. This can include selecting or enabling and deselecting or disabling one or more of auto-gratuities, declared tips, and CC tips. For (ii), the user can select options for tips that are brought in from other sources such as sales receipts. This can include selecting or enabling and deselecting or disabling other CC tips. In response to selecting or deselecting these options, a button on user interface 201 can become activated. The button can display, for example, text that indicates “Next: Who is receiving from the tip pool?” The user can interact with the button and proceed to the next interface. Selecting this button attributes the selected or deselected options for user interface 201 to the creation of the tipping pool.

FIG. 2C is an example of another user interface 203 that illustrates the creation of a resource pool for aggregation and distribution. User interface 203 is a continuation of user interface 201. Specifically, in response to the user interacting with the button user interface 201 to proceed to the next interface, user interface 203 is displayed on the client device.

The user interface 203 can indicate that user can provide options related to “Who adds to the pool?” This can include, for example, selecting which roles contribute tips to the tip pool. The user can indicate various contributors who can contribute to the tipping pool, such as, which roles, users, departments, or others contribute to the pool. This can include, for example, a waiter, a bartender, a chef, a waitress, a hostess, and other. Users and departments can be input as contributors that have access to the server, such as server 106. Moreover, the user can select a percentage amount each user, role, department, or other can contribute to the tip pool. User interface 203 can also enable the user to select types of contribution methods for each role, user, department, or other. In response to entering the contributors to the tip pool, their corresponding tip percentage, and any other contribution criteria, the button on user interface 203 may become activated. The button can display, for example, text that indicates “Next: Who is receiving from the pool?” The user can interact with the button and proceed to the next interface.

FIG. 2D is an example of another user interface 205 that illustrates the creation of a resource pool for aggregation and distribution. User interface 205 is a continuation of user interface 203. Specifically, in response to the user interacting with the button user interface 203 to proceed to the next interface, user interface 205 is displayed on the client device.

The user interface 205 can indicate that the user can provide options related to “Who adds to the pool?” This can include, for example, selecting which sources contribute tips to the tip pool. The sources that can contribute to the tip-pool can include (i) tips from time punches and (ii) other contribution sources. For (i), the user can select one or more contributors, e.g., role, user, or department, that can contribute tips from time punches and a percentage amount that each of these contributors are able to contribute to the tip pool. The tips from time punches can include, for example, tips that are brought in from staff punching in and out during a shift.

For (ii), the user can select one or more contributors that can contribute tips from other contribution sources and a percentage amount that each of these contributes are able to contribute to the tip pool. The tips from other contribution sources can include various contributors. Moreover, the user interface 205 can enable the user to indicate that any tips received from other contribution sources for this tip-pool be contributed to the unassigned tips bucket, e.g., third bucket, for this tip pool. In response to entering the contributors to the tip-pool and their corresponding tip percentage for each of the contribution sources, the button on user interface 205 may become activated. The button can display, for example, text that indicates “Next: Who is receiving from the pool?” The user can interact with the button and proceed to the next interface.

FIG. 2E is an example of another user interface 207 that illustrates the creation of a resource pool for aggregation and distribution. User interface 207 is a continuation of user interface 205. Specifically, in response to the user interacting with the button user interface 205 to proceed to the next interface, user interface 207 is displayed on the client device.

The user interface 207 can indicate that the user can provide options related to “Who is receiving from the pool?” This can include receivers such as, for example, users, roles, departments, and others. Moreover, the user interface 207 enables the user to select different distribution methods such as, for example, equal distribution method, a point distribution method, and a percent distribution method. The user interface 207 enables the user to enter receivers as well as a percentage and other criteria for receiving distribution amounts. In some examples, if the percentage for each receiver of the tip-pool accrues to an amount higher than 100%, the user interface 207 can throw an error and request the user to correct the percentage distributions for each user so the accrued amount is equivalent to or below 100%. In response to entering the receivers of the tip-pool and selecting a type of distribution method, the button on user interface 207 may become activated. The button can display, for example, text that indicates “Next: One Last Review”. The user can interact with the button and proceed to the next interface.

FIG. 2F is an example of another user interface 209 that illustrates the creation of a resource pool for aggregation and distribution. User interface 209 is a continuation of user interface 207. Specifically, in response to the user interacting with the button on user interface 207 to proceed to the next interface, user interface 209 is displayed on the client device.

The user interface 209 can indicate a summary of the created tip pool. For example, the user interface 209 can indicate to “Take a look at the different sections before publishing ‘Pizza tip pool’.” The user interface 209 can include (i) a summary of how tips are added and (ii) a summary of how tips are distributed. For (i), the user interface 209 can indicate, for example, that the user selected percentage of tips for contributions, tips are added automatically from your POS device, the tip types are included, e.g., AutoGrat, Credit Card, Cash, and which contributors can add tips, e.g., server (front of house) at a contribution rate of 100%. Other examples are also possible. For (ii) the user interface 209 can indicate, for example, the user selected percentage-based distributions, data indicating that based on the number of hours worked, tips are distributed by percentage, and which receivers are receiving the distributed tips, e.g., servers (front of house) at a contribution rate of 80% and kitchen staff (back of house) at a contribution rate of 20%. In some examples, the button on user interface 209 can be selected. The button can display, for example, text that indicates “Save my new tip pool.” The user can interact with the button and proceed to the next interface. The user can interact with the button at any time while reviewing user interface 209.

FIG. 2G is an example of another user interface 211 that illustrates the creation of a resource pool for aggregation and distribution. User interface 211 is a continuation of user interface 207. User interface 211 is similar to user interface 209 but different in that different contribution and distribution methods are used. For example, in user interface 211, the user selected “percentage of tips” as the contribution method. The user selected points weighting for the distribution method in user interface 211. Moreover, the servers can be attributed 2 points whereas the kitchen staff can be attributed 1 point. In the points weighting system, the system can distribute tip by weighted points based on the number of hours worked.

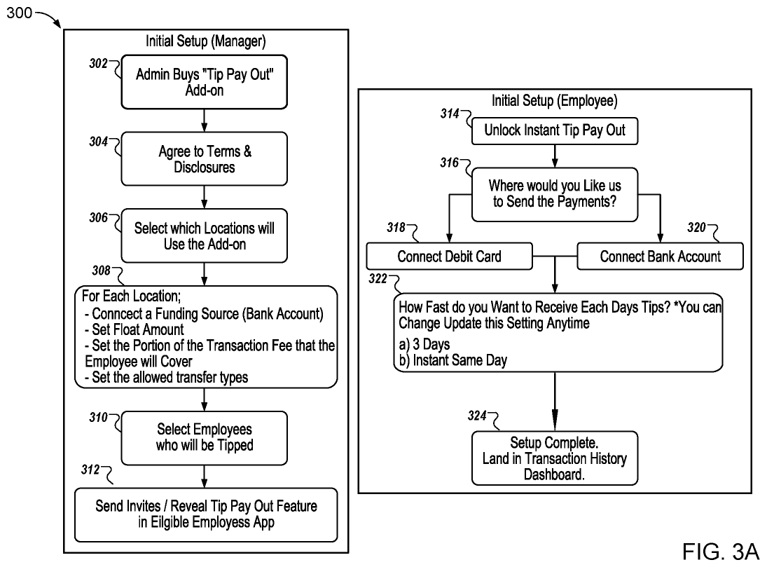

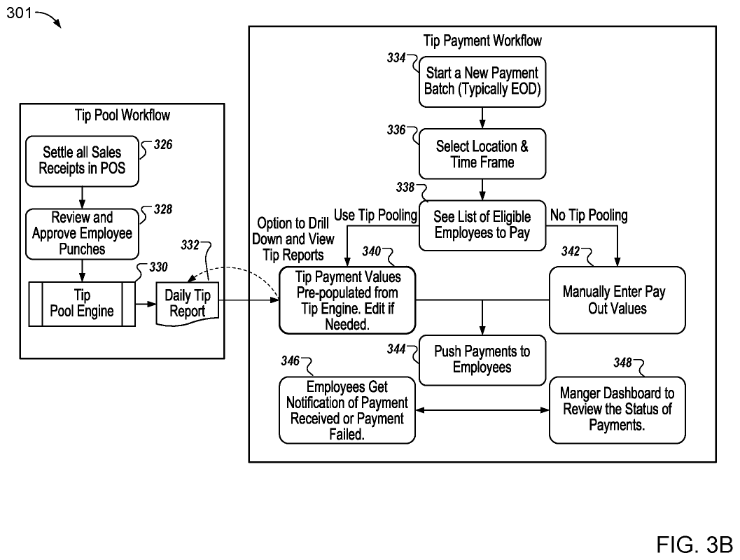

FIG. 3A illustrates examples of flow diagrams 300 for creating instant distribution from a created resource pool. A server, such as server 106, can perform the flow diagram 300. A manager can perform the stages 302 through 312 or admin seeking to add a tip pay out option. An employee seeking to unlock the tip pay out option can perform the stages 314 through 324.

During (302), an administrator can buy a tip pay out option. The tip pay out option can represent an option in which the tip payment distribution is instantaneously delivered to one of the administrator's employees. The tip payment distribution can be withdrawn from a bank account associated with the tip distribution method and distributed to the employees' employee bank account.

During (304), the administrator can agree to terms and disclosures for enabling this option. The administrator can also disagree to terms and disclosures, which will cease the set-up of the initial add-on option.

During (306), the administrator can select which locations will use this add-on. The administrator can select locations that include enabled POS devices such as, for example, restaurants, cafes, bars, ski resorts, and other locations, to name a few examples. The administrator can also select locations that do not include enabled POS devices, but these locations enable users to use their client devices for providing tip contributions to a resource pool.

During (308), the administrator can select, for each location entered in 306, various attributes associated with the tip-pool add-on service. This can include, for example, connecting a funding source, setting a float amount, setting the allowed transfer types, setting the portion of the transaction fee that the employee will cover, and other characteristics. A funding account can include, for example, a personal bank account of the employee. The allowed transfer types can include, for example, debit card deposits, bank account deposits, cash deposits, and other types of deposits. The float amount can include an amount to be loaned to the employee by the company. The set portion of the transaction fee can include, for example, a percentage or fee charged by the third-party payroll for the employee to cover when performing the instant pay aspect.

During (310), the administrator can select the employees who will be tipped. This can include employees that will receive tip contributions. For example, these employees can include various users, roles, departments, and others who may work at the one or more locations defined in (306). These employees can include, for example, chefs, sous chefs, bartenders, waiters, waitresses, janitorial staff, bus boys, hosts, and hostesses, to name a few examples.

During (312), the administrator can instruct the server to send invitations to the employees selected in 310 to have access to the tip pay out feature. The server can send these invitations to the employees' email addresses, mobile applications on their client devices, home addresses, work addresses, or other addresses. The administrator may provide the server with contact information for each of the employees identified in (310) so the server can send invitations to each of these employees. The invitations can include, for example, descriptions of the tip pay out add-on and a link to access and/or download the add-on to their mobile application of their client device, application of their personal computer, or other.

During (314), the employees that were selected in (310) can receive an invitation to enable the tip pay out add-on feature. In some examples, an employee can download or enable the tip pay out add-on feature to their application on their client device or personal device. The employee can enable the tip pay out add-on feature and start the processes for receiving payments via the tip pay out add-on feature.

During (316), the tip pay out add-on feature on the employee's application can request, “Where would you like us to send the payments?” The employee can interact with the add-on feature to indicate one or destinations for paying the tip distributions. For example, the employee can select “Connect debit card” in (318), “Connect bank account” in (320), and other options, such as to be paid in cash or one or more types of cryptocurrency. The employee can enable one or more of the aforementioned accounts and designate a priority for depositing tip distributions. The priority can include, for example, debit card first, bank account second, and cash option third. Other examples are also possible.

During (322), the tip pay out add-on feature on the employee's application can request “How fast do you want to receive each days tips? You can change or update this setting anytime.” The employee can select an option from multiple options. In some examples, the employee can select a three day's option, in which the tip distributions will be delivered in three days for either no fee or a cheap fee. In some examples, the employee can select an instant or same day option, in which the tip distributions will be delivered the same day as they are earned. Instant or same day option can include, for example, delivery of tips as soon as they are earned or delivery of tips the same day as they are earned. In this example, the employee may be required to pay a fee of $0.75 per instant transaction. In some examples, the employee can select other options where the delivery of tips can be delivered on custom timelines according to a set fee.

During (324), the setup for the employees tip pay out add-on feature is complete. (314) through (324) can be performed for each employee who received an invitation to enable the tip pay out add-on in (312). After the setup completes, the employees can expect to receive tip distributions according to their tip pay out add-on feature instructions.

FIG. 3B illustrates examples of flow diagrams 301 for creating instant distribution from a created resource pool. A server, such as server 106, can perform the flow diagram 301. The stages (326) through (332) can represent the processes for a tip-pool workflow. The stages (334) through (348) can represent the processes for a tip payment workflow.

During (326), the employees of a particular location can settle all sales receipts in one or more POS devices. The employees can enter their sales receipt information into each of the one or more POS devices. A manager can review the entered sales receipt information entered into each of the one or more POS devices and ensure the entered sales receipt information is accurate and devoid of any errors.

During (328), the manager can also review and approve employee time punches. This can include, for example, the manager approving that each employee properly clocked in, e.g., started, and clocked out, e.g., finished, at his or her designated shift. If a manager notices an error with an employee time punch, the manager can correct the employee time punch or request the employee correct the time punch. Otherwise, the manager can approve each of the employee time punches. In some examples, the POS devices can transmit its resource data and corresponding labor data to the server.

During (330), a tip-pool engine of the server can perform the processing of tip-pooling. (330) is similar to the processes performed during 122 of FIG. 1B.

During (332), the tip-pooling engine can produce a daily tip report. The tip-pooling engine can produce a tip report daily, weekly, monthly, annually, or other. (332) is similar to the processes performed during 126 of FIG. 1B.

During (334), the tip-pooling engine can initiate a new payment batch. In some implementations, the tip-pooling engine can initiate a new payment batch by determining which locations and employees for performing the tip payout. Specifically, the tip-pooling engine can start a new payment batch at various times throughout the day. For example, the tip-pooling engine can initiate a new payment batch in the morning, in the afternoon, at night, or when a particular company closes.

During (336), the tip-pooling engine can select a location and a time frame for initiating a new payment batch. The location can include, for example, a particular restaurant, a cafe, a hotel, or another location. The time frame can include, for example, a morning shift, an afternoon shift, eight hours of a workday, day parts shift, and other times. The tip-pooling engine can identify locations and certain time frames of the day in order to accumulate tip distributions from that particular location for that particular time of the day. For example, the tip-pooling engine can identify a pizza restaurant and identify a time range of 8:00 AM to 12:00 PM, and distribute allocated tips that were acquired at that specific location during the identified time range.

During (338), the tip-pooling engine can retrieve a list of eligible employees to pay for tip-pooling. These employees may be the employees that were sent invites in (312). In some implementations, a user can select one or more eligible employees from the list of employees to the payment distributions. In some implementations, the tip-pooling engine may automatically select one or more eligible employees from the list of employees to the payment distributions.

The tip-pooling engine can determine how to distribute payment to eligible employees based on the type of eligibility. For example, during (340), the tip-pooling engine can identify one or more employees involved in the tip-pooling function. These employees may receive tip payment values pre-populated from the tip-pooling engine, such as those identified in the daily tip report of (332). Additionally or alternatively, during (342), the tip-pooling engine can identify one or more employees that are not involved in the tip-pooling function. These employees may receive pay out values that are manually entered. For example, a manager or administrator may manually enter the payout values for these employees.

During (344), the tip-pooling engine can push payment distributions to the employees identified in (338), (340), and (342). The tip-pooling engine can push payment distributions to employees according to the preferences set up by the employees in (316), (318), and (320) from FIG. 3A. For example, the tip-pooling engine can push payment distributions to employees to their connected debit accord, through a connected bank account, through a connected cryptocurrency account, or by sending cash to the employees.

During (346), the employees that received the push payment can receive a notification of payment received or payment failed. For example, these employees may receive a text notification, an email notification, a phone call, a notification on their mobile application, indicative of whether the tip-pooling engine was successful in transmitting payment or was not successful. The tip-pooling engine may retry a different account for transmitting payment if the first account failed. The tip-pooling engine may repeat this process until the payment is successfully transmitted.

During (348), the manager can review the status of the distribution payments to each of the eligible employees. For example, the manager can determine whether a distribution payment was successful, unsuccessful, or is pending. A pending distribution payment is one in which the distribution payment has yet to be processed and transmitted. The manager can also review these payments and determine whether any errors exist with these payments or whether to validate the distribution payments to each of the employees.

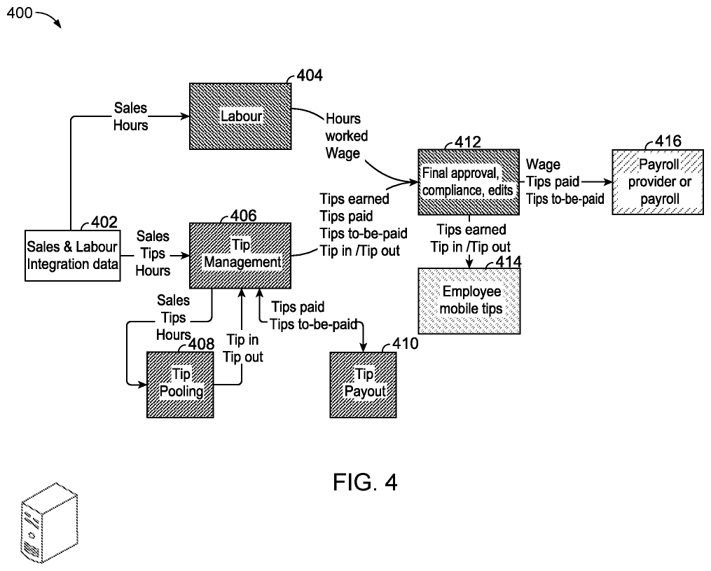

FIG. 4 illustrates an example of a flow diagram 400 for resource pool aggregation and distribution using platformization. A server, such as server 106 from system 100 and 101 or another third-party server, can execute the flow diagram 400. The flow diagram 400 includes similar stages to those described in systems 100 and 101 and processes in flow diagrams 200 and 301. In particular, a manager or admin seeking to add a tip pay out option can initiate the stages of flow diagram 400.

In some implementations, the flow diagram 400 illustrates a flow process for platformizing the resource pooling aggregation and distribution of resources. In further detail, third parties may desire to access and/or utilize data used by server 106, for example. The server 106 can deploy the data utilized by server 106 and perform various processes on the accessed data using their own system. For example, the server 106 can deploy resource and labor data to other third-party systems. The third-party systems can use the deployed resource data and/or labor data to perform processes related to resource aggregation, resource pooling, resource payouts, and resource documentation, to name a few examples. In further detail, the third-party systems can consume labor and resource data from the server 106 and/or from their respective POS devices, aggregate the resource data into one or more resource pools, and distribute the aggregated resource data to their respective employees, using the one or more deployed models from server 106. The third-party systems can utilize the data provided by the server 106 to perform the processes shown in the flow diagram 400, as outlined below. Moreover, the third-party systems can perform other functions on the data provided by the server 106.

A server, such as a server computer at a third-party system, can receive resource data and labor data for various transactions associated with one or more data sources (402). The data sources can provide resource data and labor data using their own specified proprietary information from various locations. These data sources can be associated with different external systems and communicate with the server over a network. In some examples, the resource data can include transactional information, such as sales data, tips data, sales over hours worked, and tips over hours worked, to name a few examples. In some examples, the labor can include worked hours or time punches information. The processes performed during (402) is similar to the processes performed during (108).

The server can receive and analyze the labor data from the one or more data sources (404). The server can extract various information about the hours worked by a particular employee from the labor data. For example, the server can extract from the labor data a merchant name, a merchant location, hours worked, merchant category, data source identifier, which role worked on the time punches, which department worked on the time punches, and employee identifier. In some examples, the server can analyze the extracted information from the labor data to determine a time period that corresponds with hours worked for the employee. Based on the identified time period, the server can identify which specific resource pool or resource pools the corresponding resource data belongs. The processes performed during (404) is similar to the processes performed during (112).

The server can analyze the resource data and the labor data using a tip management module (406). In particular, the tip management module can normalize or clean the resource data and the labor data provided from each of the one or more data sources to a similar format. For example, the tip management module can normalize the resource and labor data by (i) identifying a type or which of the data sources transmitted the resource and labor data and (ii) performing a corresponding normalizing function on the resource and labor data. In this manner, the tip management module can apply the same functions to normalized resource and labor data. Without performing the normalizing functions, the unnormalized resource data and unnormalized labor data provided over one or more different protocols would be not be properly processed by the same functions of the tip management module. The processes performed during (406) are similar to the processes perform during (110).

The tip management module can provide the normalized resource and normalized labor data to the tip pooling engine (408). This tip pooling engine of FIG. 4 is similar and performs similar functions as the tip pooling engine 112. As shown in flow diagram 400, the tip pooling engine can perform the processes of allocating the normalized resource data into one or more tipping buckets associated with one or more resource pools according to a predetermined set of contribution rules. The tip pooling engine can determine which of the one more resource pools are to receive the allocated normalized resource data using the normalized labor data. Additionally, the tip pooling engine can be utilized to generate the tips in and tips out data from each of the tipping buckets to various employees, departments, or roles, based on amounts contained in the tipping buckets and the tipping buckets' corresponding set of rules. The tip pooling engine can provide the generated tips in and tips out data to the tip management module for distributing the tip pay outs.

In response to the tip management module receiving the generated tips in and tips out data from the tip pooling engine, the tip management module can generate a data object that tracks tips paid and tips to-be-paid (406). The data object can include various attributes related to the tips paid and tips to be paid calculations. These various attributes can include, for example, an enumerated type that represents the calculation-either (i) tips paid before payroll or (ii) tips paid on payroll; the arithmetic type for the calculation-either (i) addition or (ii) deduction/subtraction; and, the “tip sources” that are considered for the calculation—the devices that provide the resource data to the server. Using these data objects, the tip management module can determine tips paid and tips to be paid information. The processes performed in (406) is similar to the processes performed in (114) and (116).

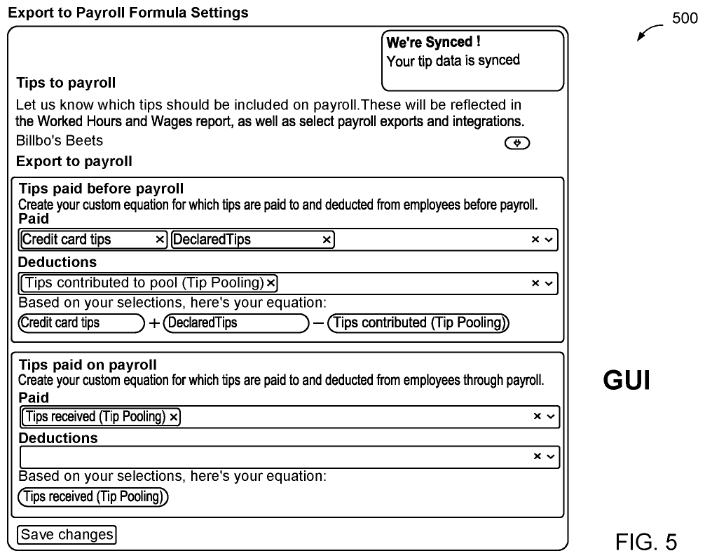

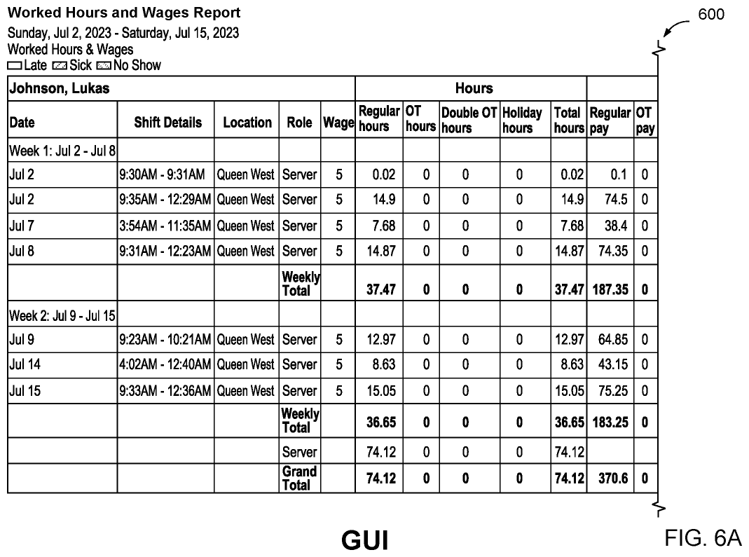

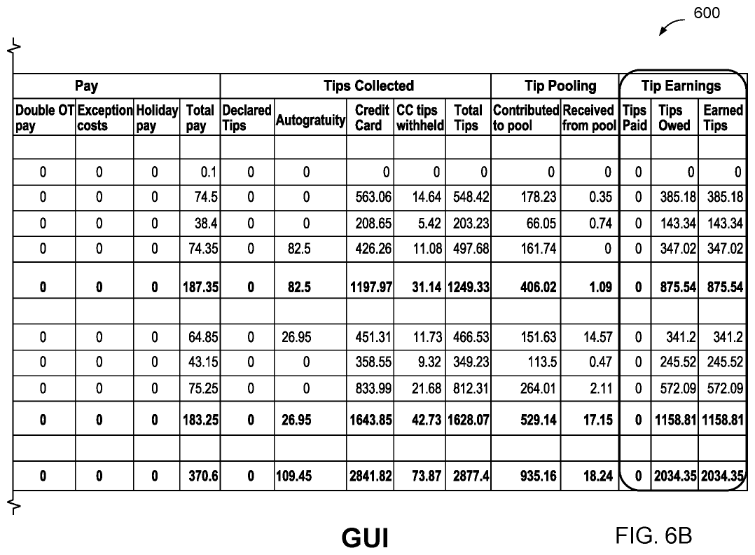

In particular, the tip management module can utilize a service that accepts a time punch and calculates “tip export” fields using configurable formulae settings. For example, as shown in the Worked Hours and Wages Report detailed in FIGS. 6A and 6B, the values illustrated in the Tip Earnings column are calculated using the configurable formulae settings from FIG. 5. FIG. 5, which illustrates the export to payroll formula settings, is an example of a user interface 500 or dashboard that illustrates the creation of a customizable distribution from a created resource pool and enables a user of the third-party system to configure the formulae settings. In particular, FIG. 5 illustrates the user can enter which tips or resources should be included on payroll, which are ultimately reflected in the Worked Hours and Wages Report shown in FIGS. 6A and 6B, as well as select payroll exports and integrations.

For example, the user can enter in FIG. 5's dashboard how tips are calculated for either (i) tips paid before payroll, e.g., tip payout 410 or (ii) tips paid on payroll, e.g., payroll provider 416. In the tips paid before payroll graphical user interface (GUI) element, the user can create a custom equation for which tips are paid to and deducted from employees contributions before payroll. The user can select from a preconfigured set of inputs or enter a respective custom input. In some examples, FIG. 5 illustrates the user entered “Credit card tips” and “Declared Tips” as part of the equation for such payments. In some examples, FIG. 5 illustrates the user entered “Tips contributed to pool (Tip Pooling)” as a deduction. This deduction represents the particular resource pool to which the user contributes their earned tips. As result, FIG. 5 illustrates the generated customizable formula, which includes “Credit card tips”+“Declared Tips”—“Tips contributed (Tip Pooling)”. In some implementations, the user interacting with the dashboard can customize other equations.

In the tips paid on payroll GUI element, the user can create a custom equation for which tips are paid to and deducted from employees through payroll. The user can select a preconfigured set of inputs or enter a custom input. In some examples, FIG. 5 illustrates the user enter “Tips received (Tip Pooling)” as part of the equation for payments. In some examples, FIG. 5 illustrates the user has not entered a deduction as part of the equation. Thus, FIG. 5 illustrates the generated customizable formula, which includes “Tips received (Tip Pooling)”. In this example, no deductions are to be performed for the tips paid on payroll. Other examples for customizing equations are also possible.

In some implementations, the tip management module utilizes a domain service for calculating the tip pay period as well as calculating the “live” version that is accessed during the Tip Pay Period. In particular, the domain service calculates and determines values for all appropriate field for each user, at a daily cadence for the pay period. The domain service can calculate (i) earned_tips using the tips_to_be_paid total from the platformization data, (ii) paid_on_shift using the tips_paid total from the platformization data, and (iii) paid_on_tip_payouts as the sum of successful payouts for that user. The domain service can display the results of (i) earned_tips, (ii) paid_on_shift, and (iii) paid_on_tip_payouts in the user interface 600 displayed in FIGS. 6A and 6B.

Moreover, the tip management module can update the values of the table illustrated in FIGS. 6A and 6B by querying for all tip pay periods for a location using the endpoint created. In response, the query can return all available tip pay periods to render on the display according to the date selector at the top of the page. Each of the available tip pay periods can be provided in a catalog and displayed in the table shown on FIGS. 6A and 6B.

In some implementations, each time the date selector is modified, a subsequent request is performed. For example, the user can interact with the dashboard and change the date or range of dates shown on the date selector. In response, the tip management module can perform the subsequent request for all tip pay periods for a particular location, extracting the cached values, and calculating the live tip totals for a given pay period on the fly. In this manner, a user of the third-party system can view information on the dashboard information each individual that contributes to a resource pool. This information can include, for example, dates worked, shift details, location of work, role, wage number, regular hours worked, overtime (OT) hours, double OT hours, holiday hours, total hours, regular pay, OT pay, double OT pay, exception costs, holiday pay, total pay, declared tips, auto-gratuity, credit card tips, credit card tips withheld, total tips, amount of tips contributed to pool, amount of tips received from pool, tips paid via tip earnings, tips owed via tip earnings, and earned tips via tip earnings. Other examples are also possible.

Returning to FIG. 4, the tip management module can provide the calculated tips paid and tips to be paid to the tip payout (410). The tips paid and tips to be paid to the tip payout can be output according to the customizable formula entered by the user in FIG. 5 under “Tips paid before payroll”, for example. Here, the server can pay out the tips paid and tips to be paid using, for example, debit card deposits, bank account deposits, cash deposits, or any other type of deposits. The tip pay out option may be setup using the processes performed in the flow diagrams 300 and paid out using the instant distribution performed in the flow diagrams 301, for example.

The tip management module can transmit tip information to final approval and compliance for tips to be paid out under payroll (412). The tip information can include, for example, tips earned, tips paid, tips to be paid out, tips in, and tips out, for one or more individuals. This information can be extracted from one or more worked hours and wages reports, such as the worked hours and wages report shown in FIGS. 6A and 6B. Here, the server can perform a validation check to ensure the tip information is approved, meets compliance, or requires any edits before distribution. The server or a manager can analyze the tip information to determine whether an error exists with the tip information. For example, the server can determine, for a particular individual over a given time period, whether tips earned equals tips paid plus tips to be paid out. If the server determines these numbers do not appropriately match, the server can flag an error and notify a manager to correct the issue. If the server determines the tip information passes the validation check, then the server can pay the tips earned to the corresponding individual, which includes the tip in and tip out to the mobile device of the corresponding individual (414). In some cases, the server can retrieve from configuration settings for the individuals whether to pay the tips earned to the mobile device of the corresponding employee or to the employee's payroll. The server can send the payment to the mobile device of the corresponding employee using, for example, a mobile payment application, a mobile banking application, a text message, or another form of mobile payment.

If the server determines the configuration settings indicate the employee is to be paid via the employee's payroll, then the server can pay the earned tips using the employee's payroll (416). In further detail, the server can send the earned tips information to payroll or the third-party's finance department. The finance department or another department can pay the earned tips to the employee along with their salary and other wages. In this manner, the finance department can withhold taxes for paying the salary along with the earned tips.

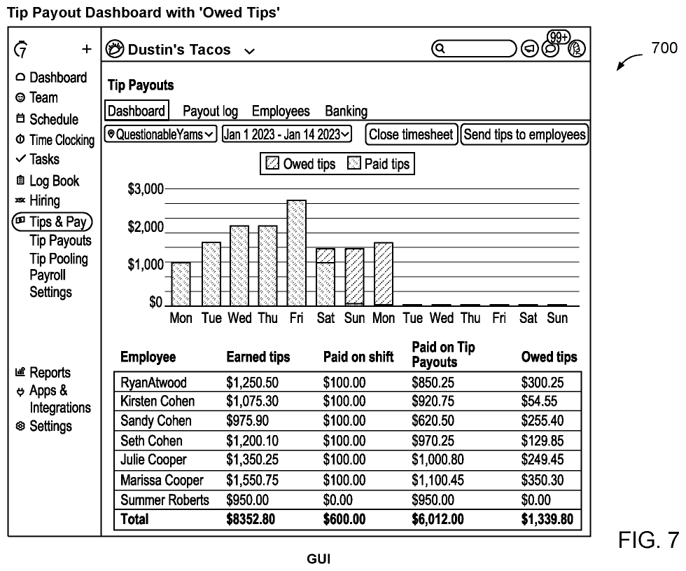

FIG. 7 is an example of a user interface 700 illustrating distribution payouts across a set time period for a created resource pool. In further detail, a user or manager accessing the third-party system that includes the deployed models can view previous distribution payouts and distributions to be paid out for the created resource pool. For example, the user interface 700 can include a graphical display of tips information and tip payouts information for various employees. The graphical display of tips information can include owed tips and paid tips over a set time period. The graphical display can be, for example, a bar graph, line graph, or other, that illustrates paid tips to one or more employees, and owed tips to be paid to the one or more employees. In this manner, a user or managing reviewing the user interface 700 can determine an amount of tips to be paid on a given day or over the set time period.

Moreover, the tip payouts information can display for each employee in a table, for example, earned tips, tips on shift, tips paid on tip payouts, and owed tips. The table can be displayed under the graphical display on the user interface 700. The table enables the user or manager reviewing the user interface 700 to determine an amount of tips that a user earned, how much of those earned tips have been paid or distributed on the shift and tips pay out, and how much of those earned tips are remaining to be paid.

In some implementations, the user interface 700 also displays other information pertinent to the tip pooling information. In particular, a user or manager utilizing the user interface 700 can interact with and view other components, e.g., dashboard information, team information, schedule information, time clocking information, tasks information, log book information, hiring information, reports information, applications & integrations information, and settings information. The dashboard information can display information related to the third-party system and its contents. The team information can display information about the one or more employees involved in the tip payouts. The schedule information can display information about each of the one or more employees past, present, and future work schedules.

The time clocking information can display information related to when each of the one or more employees clock in and clock out at work. The task information can display information related to tasks that need to be completed by the one or more employees, e.g., update direct deposit information, update tip payout information, and other. The log book information can display information related to logged work for the one or more employees. The hiring information can display information related to one or more future employees to be hired.

The tips and pay information can display information relating to the tips payout, the tip pooling, payroll, and settings. The tips payout information, as displayed in FIG. 7, shows the graphical display of tips information and the tips payout information in the table. The tips pooling information can display information related to the aggregation and pooling of tips in buckets according to the customizable rules. The payroll information can display information related to the one or more users wage and tips payout. The settings enable the user to configure display settings, e.g., colors, graphic types, and other information of the user interface 700. The reports information can display the worked hours and wages report, as illustrated in FIGS. 6A and 6B. The apps & integration can display the one or more application programmable interfaces (APIs) that are connected to the third-party system.

In some implementations, the server can track employee performance over time and use the tracked performance to predict which employee is to work at a designated future time. In particular, the server can analyze tips earned for each employee over prior periods of time. The server can analyze an amount of tips earned for each employee at different time periods over the prior periods of time. In some examples, the server can determine, based on the analysis, that Brian, a waiter at a local restaurant, tends to earn higher tips than other employees in the morning periods at a particular location. In some examples, the server can determine, based on the analysis that Joe, another waiter at the local restaurant, tends to earn higher tips than other employees in the afternoon periods at the particular location. In this implementation, the server can utilize machine learning to predict which employee is expected to earn higher tips according to the past performance of each of the employees. Thus, the manager may designate employees to work at scheduled times in the future according to the performance of that employee predicted by the machine learning model.

For example, the manager can provide data representing a time of day to the machine learning model, and the machine learning model can output, for each employee, a statistical likelihood that the employee will have high performance, e.g., earn the highest amount of tips, for that designed time of day. The manager or server can then designate the employee that has the statistical likelihood that satisfies a particular threshold, e.g., exceeds or meets, as the employee to schedule for that time of day at that location.

The server can train the machine learning model using, for example, (i) data identifying the employee, (ii) data identifying the time of day the employee worked, (iii) data identifying an amount of tips earned by that employee during that time of day, and (iv) the location worked by that employee. In this manner, the machine learning model can be trained using past data of each of its employees in order to predict future performance of each of the employees. The type of machine learning model can include, for example, a logistic regression, K-Nearest Neighbors approach, or other types of models. The trained machine learning model can be continuously retrained with an amount of earned tips the predicted employee made on that day. This can be beneficial to improve the trained machine learning model's performance when the predicted employee did not earn the highest amount of tips at the designated time.

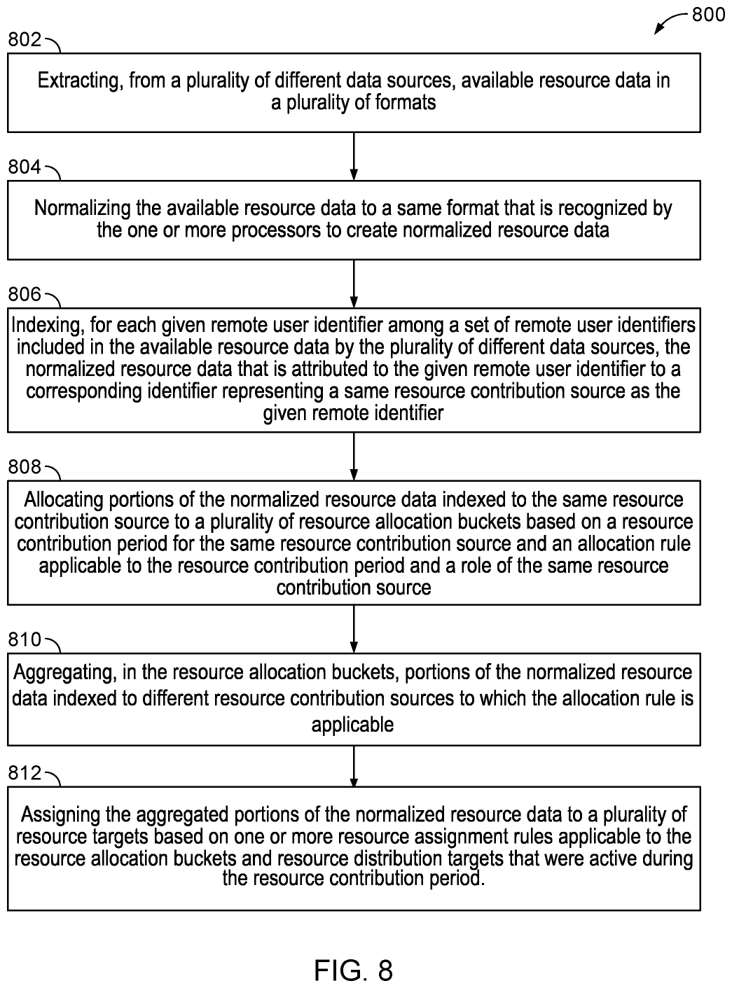

FIG. 8 is a flow diagram that illustrates an example of a process 800 for aggregating resource data and distributing the aggregated resource data according to criteria. The server 106 of system 100 can perform the process 800.

The server can extract, from a plurality of different data sources, available resource data in a plurality of formats (802). The server can communicate with a variety of different data sources over a network. The data sources can include devices in which customers can enter tips or other resources when paying for service at a service provider. The data sources can include, for example, POS systems, mobile devices with their applications, a personal computer, a handheld device, a portable device, a tablet, an embedded microprocessor device, and other devices. Each of the data sources may be located at different geographic locations. For example, when a customer applies a tip when paying for a bill of a service, the customer applies the tip by performing a payment, such as an electronic payment with the data source. The data source can then transmit resource data, e.g., sales receipt data that includes tips, and labor data to the server over the network in real time in response to receiving the payment from the customer.

In some examples, the server can fetch the available resource data from a subset of the plurality of different data sources on a periodic basis based on a type of each of the data sources. In some examples, the server can receive, from the plurality of different data sources, the available resource data in the plurality of formats. Each of the data sources can communicate the available resource data to the server according to their own respective proprietary information, e.g., protocol or specified communication mechanism. The available resource data in the plurality of formats can include, for example, a sales receipt, a time stamp of a transaction, a remote user identifier corresponding to a user that submitted the available resource data, and a device ID corresponding to a data source that transmitted the available resource data.

The server can normalize the available resource data to a same format that is recognized by the server to create normalized resource data (804). Specifically, the server can perform the normalizing by identifying a type of a data source that transmitted the available resource data and identifying an application programmable interface associated with the type of the data source that transmitted the available resource data. In response, the server can generate the normalized resource data by applying one or more functions of the application programmable interface to the available resource data associated with the type of the data source.

For example, the server, based on the type of data source that transmitted the resource data, can apply one or more algorithmic functions or rules to normalize the received data to a format understood by the server. The server can identify the type of normalization functions to apply based on an identification of the data source that transmitted the data. For example, the server can determine from the received data the data source based on identifying a pattern in the data, identifying a code in the data that identifies the data source and is uniquely identifiable across all data from each of the data sources, or identifying a timing slot in which the data was received, which indicates to the server which data source transmitted the data. In response, the server can identify one or more corresponding algorithms, e.g., a decryption algorithm, a descrambling algorithm, a frame structure that defines where the payload and headers are located, and other types of algorithms. In response to normalizing the resource data to a format understood by the server, the server can extract the resource data from the normalized data. The extracted resource data can include the data relevant to one or more payment transactions associated with a particular data source.

The server can index, for each given remote user identifier among a set of remote user identifiers included in the available resource data by the plurality of different data sources, the normalized resource data that is attributed to the given remote user identifier to a corresponding identifier representing a same resource contribution source as the given remote identifier (806). Specifically, for each available resource data from each of the plurality of different data sources, the server can perform the following: (i) identifying the set of remote user identifiers, (ii) extracting a remote user identifier from the normalized resource data, (iii) mapping the extracted remote user identifier to the corresponding identifier from the set of remote user identifiers that represents the same resource contribution source as the given remote identifier, and (iv) storing the normalized resource data in an indexed fashion using the corresponding identifier in memory.

For example, the resource data may include an identifier, e.g., a user identifier, that identifies the user who entered the payment transaction into the corresponding data source. The server can then identify an internal identifier using the user or role identifier extracted from the normalized data. The server can perform various processes to identify users or roles worked from the resource data extracted from the normalized data. For example, when the server receives data and extracts resource data from the data, the server can perform inferences to determine who the tips should be contributed to for a particular time period. For example, the server can identify from the resource data user or role identifiers and corresponding time stamps. Then, the server can identify which user or role worked during that time period of the time stamps and seek to identify a corresponding labor data, e.g., time punch data, that worked under the same user or role and where the resource data, e.g., sales receipt, falls under the same time punch data. The server can accumulate the sales data for the identified user and identify the internal identifier for the identifier user.

The server can access a mapping of identifiers in its database. The database can store multiple mappings of user identifiers extracted from normalized resource data to internal identifiers for a particular resource pool. The server can use these mappings to retrieve an internal identifier from the extracted user identifier and can store the resource data and the corresponding labor data in the database according to the internal identifier, e.g., such as by way of an index in the database. Consequentially, the server 106 can store large portions of resource data and corresponding labor data in the database and maintain tracking of the resource data and corresponding labor data for individual employees over large portions of time. Moreover, the server can store data that identifies which corresponding internal identifiers map to which specific resource pool. As such, the server 106 can access data that identifies the specific resource pool using the identified corresponding internal identifiers.

The server can allocate portions of the normalized resource data indexed to the same resource contribution source to a plurality of resource allocation buckets based on a resource contribution period for the same resource contribution source and an allocation rule applicable to the resource contribution period and a role of the same resource contribution source (808). Specifically, the server can identify a user or role who contributed the resource data based on the remote user identifier and identify a format indicative of how the resource data was received by a corresponding data source, wherein the format indicative of how the resource data was received comprises (i) resource data from time entries and (ii) resource data from receipt produced by the corresponding data source. Moreover, the server can identify a resource allocation bucket from the plurality of resource allocation buckets to allocate portions of the normalized resource data based on (i) the identifier user who contributed the resource data, (ii) the format indicative of how the resource data was received by the corresponding data source, (iii) the resource contribution period, (iv) the allocation rule applicable to the resource contribution period, and (v) the role of the same resource contribution source. The plurality of resource allocation buckets can include, for example, (i) one or more buckets associated with the corresponding identifier representing the same resource contribution source for the normalized resource data associated with the remote user identifier, (ii) one or more buckets for the normalized resource data that is associated with a time punch entry system, and (iii) one or more buckets for the normalized resource data that is unassigned to the remote user identifier. Other examples are also possible.

For example, the server can determine how to allocate the indexed resource data in the database to one or more buckets of the resource pools based on identified resource pool, contribution criteria, distribution criteria, and transactional information. The server can determine, based the internal identifiers stored in the database, the access or correspondence a user or role has to various resource pools. The server can identify determine a number of buckets in each resource pool and identify a function for each of the buckets in each resource pool to determine where to contribute the stored indexed resource data. For example, in one resource pool, a first bucket can store accumulated tips from a user, a second bucket can store resource data that does not belong to any contribution rules, and a third bucket can store resource data in which the server is not able to identify a role for the labor data or the server is not able to identify the labor data for any of the roles.

The server can also determine contribution criteria or rules for the various users or roles associated with the internal identifiers and the corresponding tipping pools. In some examples, the contribution criteria can be defined on a user or role basis and can be defined according to one or more mechanisms indicating how a user or role contributes to a specific tipping pool. The mechanisms can include, for example, (i) a percentage of tips contribution and (ii) a percentage of sales contribution. In some examples, the distribution criteria can be defined based on a user, role, and/or departments and can indicate by what mechanism these parties receive a portion of the allocated resource data from the resource pool. The portion of the allocation resource data can come from one or more buckets in the corresponding resource pool. The mechanism for the distribution can include, for example, an equal distribution method, a point distribution method, and a percent distribution method. In the equal distribution method, the server is configured to distribute an equal portion of the normalized resource data from each resource allocation bucket of the plurality of resource allocation buckets. In the point distribution method, the server is configured to distribute a ratio of the normalized resource data from each resource allocation bucket of the plurality of resource allocation buckets based on the designated distribution. In the percent distribution method, the server is configured to distribute a percentage of the normalized resource data from each resource allocation bucket of the plurality of resource allocation buckets based on a designated distribution. In some implementations, a specific resource pool is associated with a single distribution method. In some implementations, if a specific resource pool is a cascaded resource pool, then the cascaded resource pool may include more than one type of distribution method.

The server can perform the tip allocation process into one or more buckets of the resource pools by gathering accrued tips for a given period and sales receipts for the given period. In response, the server can infer which user or users worked a specific role according to the accrued tips and the time punches. Specifically, the server can perform a real time inference on the sales tips, relate the sales tip back to time punches to get an accurate account of the individual tip amounts over all the sales receipts that were accrued for the period. The server can perform this tip allocation process by gathering the time punches worked under the location for that given time period, gather the sales receipts that were accumulated through the time period for that location, and perform inference on the time punches so that the time punches are worked under a specific role. As such, the server can filter out the time punches that were not worked within a typical time period. This filtering ensures that the server does not contribute tips that are not related to the tip-pool and the server does not double count tips for one or more roles.

In response to determining the users or roles that worked during a given time period, the server can determine a corresponding resource pool based on the determined users or roles, and determine which bucket of the resource pool that each tip should be deposited. Then, the server can contribute the tips to the various buckets of the tip pool according to the contribution rules created for the specific users or roles of the corresponding tip pool. For example, the server can deposit $5 of tips into a first bucket of a resource pool according to the desired contribution criteria of one or more users, $2 of tips into a second bucket, and $3.50 into a third bucket of unassigned tips.

The server can aggregate, in the resource allocation buckets, portions of the normalized resource data indexed to different resource contribution sources to which the allocation rule is applicable (810). Specifically, the server can aggregate the portions of the normalized resource data from the plurality of resource allocation buckets across different servers, wherein a subset of the servers store the available resource data that are provided by the resource distribution targets separate from the plurality of different data sources. The subset of the servers that store the available resource data that are provided by the resource distribution targets separate from the plurality of different data sources include storing declared tips from the resource distribution targets that were active during the resource contribution period.

For example, the server can store the aggregated resource data across different servers, which may be located in different geographic regions. The server can also store the aggregated resource data across different servers according various criteria. The various criteria can include, for example, storing declared tips from the data sources for users or roles that were active or working during a particular resource period. The users or roles that were active or working during the resource contribution period can include one or more employees in a service industry. The resource contribution period can describe a time period during which the resource distribution targets were active, and the resource contribution period can include, for example, at least one of (i) a morning period, (ii) an afternoon period, (iii) a night time period, (iv) hours worked, and (v) a shift period of work.

For the example of declared tips, the employee can manually input the declared tips that may have been received as a cash tip. At the end of the day, the employee can clock out from their shift by entering a specific number of declared tips that were accrued through their work period. As such, the declared tips may be a separate portion of the resource data than sales information paid for by the client with their credit card, debit card, or smart phone, to name some examples. In some examples, the server can distribute declared tips to various resource pools and their corresponding buckets according to proportions of hours worked. In some examples, the server can distribute declared tips to various resource pools and their corresponding buckets based on percentage of sales or percentage of tips over different day parts schemes.

The server can assign the aggregated portions of the normalized resource data to a plurality of resource targets based on one or more resource assignment rules applicable to the resource allocation buckets and resource distribution targets that were active during the resource contribution period (812). Specifically, the server can transmit the assigned aggregated portions of the normalized resource data to the plurality of resource targets specified by the different resource contribution sources from the resource allocation buckets. Moreover, the resource distribution targets that were active during the resource contribution period includes the resource distribution targets that were working during the resource contribution period.

For example, the server can accumulate or aggregate the tips or resource data from these buckets and distribute the tips to various devices or bank accounts associated with the users or roles that use the resource pool according to specific distribution criteria. The distributed tips may come from a specific bucket or may come from one or more specific buckets. For the unassigned bucket, an administrator or admin can determine not to distribute those users that use the resource pool. The tips in the unassigned bucket(s) may be provided to the department of the service or held until a manager reviews these tip amounts and determines which user/role/departments should receive the unassigned tips.

In some implementations, the server can determine a double counting error has occurred during the distribution process. Specifically, the server can identify a resource distribution target is associated with two or more resource allocation buckets. During the identification process, the server can determine the resource distribution target is associated with the two or more resource allocation buckets and determine whether the resource distribution target has contributed an amount of resource data that satisfies a threshold tip amount across the two or more resource allocation buckets. In response to determining that the amount satisfies the threshold tip amount across the two or more resource allocation buckets, the server can traverse each resource allocation bucket of the two or more resource allocation buckets to identify the normalized resource data that are similar based on (i) a timestamp and (ii) a remote user identifier. Here, the server seeks to identify normalize resource data that exceeds a threshold tip amount, e.g., values that sum to greater than 100%, or identify normalize resource data that has been accidentally deposited in a specific bucket of a resource pool two or more times, indicative of a double counting error, for example. In response to the server determining that one or more normalized resource data across the two or more resource allocation buckets that include (i) similar amounts, (ii) similar remote user identifiers, and (iii) similar timestamps, the server can remove at least one of the normalized resource data from at least one of the resource allocation buckets to avoid double counting the normalized resource data.

For example, the server can perform the aforementioned to process to identify a cause for a double counting issue. Specifically, the server can traverse a graph of users or roles and their corresponding tip contribution. The server can tag each tip contribution for a user and sum each tip contribution for the user. When the sum for each tip contribution for a user exceeds 100% of a reported tip earnings amount, the server can seek to identify a tip or tips that push the overall total tip contribution to be greater than 100% to indicate that tips may have been double counted. In response to identifying a tip or tips that push the overall total tip contribution to be greater than 100%, the server 106 can remove or correct the tip contribution accordingly.

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions encoded on a computer-readable medium for execution by, or to control the operation of, a data processing apparatus. The computer readable medium may be a non-transitory computer readable storage medium, a machine-readable storage device, a machine-readable storage substrate, a memory device, a composition of matter effecting a machine-readable propagated signal, or a combination of one or more of them. The term “data processing apparatus” encompasses all apparatuses, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatuses.

A computer program (also known as a program, software, software application, script, or code) may be written in any form of programming language, including compiled or interpreted languages, and it may be deployed in any form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, embodiments of the invention may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the invention may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the invention, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
extracting, by one or more processors and from a plurality of different data sources, available resource data in a plurality of formats;
normalizing, by the one or more processors, the available resource data to a same format that is recognized by the one or more processors to create normalized resource data;
indexing, (i) by the one or more processors and (ii) for each given remote user identifier among a set of remote user identifiers included in the available resource data by the plurality of different data sources, the normalized resource data that is attributed to the given remote user identifier to a corresponding identifier representing a same resource contribution source as the given remote identifier;
allocating, by the one or more processors, portions of the normalized resource data indexed to the same resource contribution source to a plurality of resource allocation buckets based on a resource contribution period for the same resource contribution source and an allocation rule applicable to the resource contribution period and a role of the same resource contribution source;
aggregating, by the one or more processors and in the resource allocation buckets, portions of the normalized resource data indexed to different resource contribution sources to which the allocation rule is applicable; and
assigning, by the one or more processors, the aggregated portions of the normalized resource data to a plurality of resource targets based on one or more resource assignment rules applicable to the resource allocation buckets and resource distribution targets that were active during the resource contribution period.

2. The computer-implemented method of claim 1, wherein the available resource data in the plurality of formats comprises a sales receipt, a time stamp of a transaction, a remote user identifier corresponding to a user that submitted the available resource data, and a device ID corresponding to a data source that transmitted the available resource data.

3. The computer-implemented method of claim 1, further comprising:
fetching, by the one or more processors, the available resource data from a subset of the plurality of different data sources on a periodic basis based on a type of the data sources; or
receiving, by the one or more processors and from the plurality of different data sources, the available resource data in the plurality of formats.

4. The computer-implemented method of claim 1, wherein normalizing the available resource data to the same format that is recognized by the one or more processors to create normalized resource data further comprises:
identifying, by the one or more processors, a type of a data source that transmitted the available resource data;
identifying, by the one or more processors, an application programmable interface associated with the type of the data source that transmitted the available resource data; and
generating, by the one or more processors, the normalized resource data by applying one or more functions of the application programmable interface to the available resource data associated with the type of the data source.

5. The computer-implemented method of claim 1, wherein indexing, (i) by the one or more or processors and (ii) for each of the given remote user identifier among the set of remote user identifiers included in the available resource data by the plurality of different data sources, the normalized resource data that is attributed to the given remote user identifier to the corresponding identifier representing the same resource contribution source as the given remote identifier further comprises:
for each available resource data from each of the plurality of different data sources:
identifying, by the one or more processors, the set of remote user identifiers;
extracting, by the one or more processors, a remote user identifier from the normalized resource data;
mapping, by the one or more processors, the extracted remote user identifier to the corresponding identifier from the set of remote user identifiers that represents the same resource contribution source as the given remote identifier; and
storing, by the one or more processors, the normalized resource data in an indexed fashion using the corresponding identifier in memory.

6. The computer-implemented method of claim 5, wherein allocating portions of the normalized resource data indexed to the same resource contribution source to the plurality of resource allocation buckets based on the resource contribution period for the same resource contribution source and an allocation rule applicable to the resource contribution period and the role of the same resource contribution source further comprises:
identifying, by the one or more processors, a user who contributed the resource data based on the remote user identifier;
identifying, by the one or more processors, a format indicative of how the resource data was received by a corresponding data source, wherein the format indicative of how the resource data was received comprises (i) resource data from time entries and (ii) resource data from receipt produced by the corresponding data source; and
identifying, by the one or more processors, a resource allocation bucket from the plurality of resource allocation buckets to allocate portions of the normalized resource data based on (i) the identifier user who contributed the resource data, (ii) the format indicative of how the resource data was received by the corresponding data source, (iii) the resource contribution period, (iv) the allocation rule applicable to the resource contribution period, and (v) the role of the same resource contribution source.

7. The computer-implemented method of claim 1, wherein the plurality of resource allocation buckets comprise (i) one or more buckets associated with the corresponding identifier representing the same resource contribution source for the normalized resource data associated with the remote user identifier, (ii) one or more buckets for the normalized resource data that is associated with a time punch entry system, and (iii) one or more buckets for the normalized resource data that is unassigned to the remote user identifier.

8. The computer-implemented method of claim 1, wherein aggregating the portions of the normalized resource data indexed to the different resource contribution sources to which the allocation rule is applicable further comprises:
aggregating, by the one or more processors, the portions of the normalized resource data from the plurality of resource allocation buckets across different servers, wherein a subset of the servers store the available resource data that are provided by the resource distribution targets separate from the plurality of different data sources.

9. The computer-implemented method of claim 8, wherein the subset of the servers that store the available resource data that are provided by the resource distribution targets separate from the plurality of different data sources comprise storing declared tips from the resource distribution targets that were active during the resource contribution period.

10. The computer-implemented method of claim 1, wherein the resource distribution targets comprise one or more employees in a service industry.

11. The computer-implemented method of claim 1, wherein the resource contribution period corresponds to a time period during which the resource distribution targets were active, and the resource contribution period comprises at least one of (i) a morning period, (ii) an afternoon period, (iii) a night time period, (iv) hours worked, and (v) a shift period of work.

12. The computer-implemented method of claim 1, wherein assigning the aggregated portions of the normalized resource data to the plurality of resource targets based on the one or more resource assignment rules applicable to the resource allocation buckets and the resource distribution targets that were active during the resource contribution period further comprises:
determining a distribution type associated with the plurality of resource allocation buckets, wherein the distribution type comprises (i) an equal distribution configured to distribute an equal portion of the normalized resource data from each resource allocation bucket of the plurality of resource allocation buckets, (ii) a percentage distribution configured to distribute a percentage of the normalized resource data from each resource allocation bucket of the plurality of resource allocation buckets based on a designated distribution, and (iii) a points distribution configured to distribute a ratio of the normalized resource data from each resource allocation bucket of the plurality of resource allocation buckets based on the designated distribution.

13. The computer-implemented method of claim 1, wherein assigning the aggregated portions of the normalized resource data to the plurality of resource targets based on the one or more resource assignment rules applicable to the resource allocation buckets and the resource distribution targets that were active during the resource contribution period further comprises:
transmitting, by the one or more processors, the assigned aggregated portions of the normalized resource data to the plurality of resource targets specified by the different resource contribution sources; and
wherein the resource distribution targets that were active during the resource contribution period comprises the resource distribution targets that were working during the resource contribution period.

14. The computer-implemented method of claim 1, further comprising:
identifying, by the one or more processors, a resource distribution target is associated with two or more resource allocation buckets, wherein the identifying comprises:
determining, by the one or more processors, the resource distribution target is associated with the two or more resource allocation buckets;
determining, by the one or more processors, whether the resource distribution target has contributed an amount of resource data that satisfies a threshold tip amount across the two or more resource allocation buckets;
in response to determining that the amount satisfies the threshold tip amount across the two or more resource allocation buckets, traversing, by the one or more processors, each resource allocation bucket of the two or more resource allocation buckets to identify the normalized resource data that are similar based on (i) a timestamp and (ii) a remote user identifier; and
in response to determining one or more normalized resource data across the two or more resource allocation buckets that include (i) similar amounts, (ii) similar remote user identifiers, and (iii) similar timestamps, removing, by the one or more processors, at least one of the normalized resource data from at least one of the resource allocation buckets to avoid double counting the normalized resource data.

15. A system comprising:
one or more computers and one or more storage devices storing instructions that are operable, when executed by the one or more computers, to cause the one or more computers to perform operations comprising:
extracting, by one or more processors and from a plurality of different data sources, available resource data in a plurality of formats;
normalizing, by the one or more processors, the available resource data to a same format that is recognized by the one or more processors to create normalized resource data;
indexing, (i) by the one or more processors and (ii) for each given remote user identifier among a set of remote user identifiers included in the available resource data by the plurality of different data sources, the normalized resource data that is attributed to the given remote user identifier to a corresponding identifier representing a same resource contribution source as the given remote identifier;
allocating, by the one or more processors, portions of the normalized resource data indexed to the same resource contribution source to a plurality of resource allocation buckets based on a resource contribution period for the same resource contribution source and an allocation rule applicable to the resource contribution period and a role of the same resource contribution source;
aggregating, by the one or more processors and in the resource allocation buckets, portions of the normalized resource data indexed to different resource contribution sources to which the allocation rule is applicable; and
assigning, by the one or more processors, the aggregated portions of the normalized resource data to a plurality of resource targets based on one or more resource assignment rules applicable to the resource allocation buckets and resource distribution targets that were active during the resource contribution period.

16. The system of claim 15, wherein the available resource data in the plurality of formats comprises a sales receipt, a time stamp of a transaction, a remote user identifier corresponding to a user that submitted the available resource data, and a device ID corresponding to a data source that transmitted the available resource data.

17. The system of claim 15, further comprising:
fetching, by the one or more processors, the available resource data from a subset of the plurality of different data sources on a periodic basis based on a type of the data sources; or
receiving, by the one or more processors and from the plurality of different data sources, the available resource data in the plurality of formats.

18. The system of claim 15, wherein normalizing the available resource data to the same format that is recognized by the one or more processors to create normalized resource data further comprises:
identifying, by the one or more processors, a type of a data source that transmitted the available resource data;
identifying, by the one or more processors, an application programmable interface associated with the type of the data source that transmitted the available resource data; and
generating, by the one or more processors, the normalized resource data by applying one or more functions of the application programmable interface to the available resource data associated with the type of the data source.

19. The system of claim 15, wherein indexing, (i) by the one or more or processors and (ii) for each of the given remote user identifier among the set of remote user identifiers included in the available resource data by the plurality of different data sources, the normalized resource data that is attributed to the given remote user identifier to the corresponding identifier representing the same resource contribution source as the given remote identifier further comprises:
for each available resource data from each of the plurality of different data sources:
identifying, by the one or more processors, the set of remote user identifiers;
extracting, by the one or more processors, a remote user identifier from the normalized resource data;
mapping, by the one or more processors, the extracted remote user identifier to the corresponding identifier from the set of remote user identifiers that represents the same resource contribution source as the given remote identifier; and
storing, by the one or more processors, the normalized resource data in an indexed fashion using the corresponding identifier in memory.

20. A non-transitory computer-readable medium storing software comprising instructions executable by one or more computers which, upon such execution, cause the one or more computers to perform operations comprising:
extracting, by one or more processors and from a plurality of different data sources, available resource data in a plurality of formats;
normalizing, by the one or more processors, the available resource data to a same format that is recognized by the one or more processors to create normalized resource data;
indexing, (i) by the one or more processors and (ii) for each given remote user identifier among a set of remote user identifiers included in the available resource data by the plurality of different data sources, the normalized resource data that is attributed to the given remote user identifier to a corresponding identifier representing a same resource contribution source as the given remote identifier;
allocating, by the one or more processors, portions of the normalized resource data indexed to the same resource contribution source to a plurality of resource allocation buckets based on a resource contribution period for the same resource contribution source and an allocation rule applicable to the resource contribution period and a role of the same resource contribution source;
aggregating, by the one or more processors and in the resource allocation buckets, portions of the normalized resource data indexed to different resource contribution sources to which the allocation rule is applicable; and
assigning, by the one or more processors, the aggregated portions of the normalized resource data to a plurality of resource targets based on one or more resource assignment rules applicable to the resource allocation buckets and resource distribution targets that were active during the resource contribution period.
